(19) United States
(12) Patent Application Publication
(10) Pub. No.: US 2019/0378533 A1
(43) Pub. Date: Dec. 12, 2019

(54) COMPUTING DEVICES AND METHODS FOR CONVERTING AUDIO SIGNALS TO TEXT

(71) Applicant: Gene Chao, Lopez Island, WA (US)

(72) Inventor: Gene Chao, Lopez Island, WA (US)

(21) Appl. No.: 16/425,548

(22) Filed: May 29, 2019

Related U.S. Application Data
(60) Provisional application No. 62/682,064, filed on Jun. 7, 2018.

(51) Int. Cl. G10L 21/10; G10L 13/04; G10L 17/00; G10L 17/02; G10L 21/02

(52) U.S. Cl. CPC G10L 21/10; G10L 13/043; G10L 2015/025; G10L 17/02; G10L 21/0202; G10L 17/005

(57) ABSTRACT

Computer-implemented methods and computing devices for converting spoken language into text. Computer-implemented methods include receiving an input audio signal that includes spoken language uttered by a speaker, analyzing the input audio signal, and determining one or more differences between one or more measured formant values and one or more model formant values. The computer-implemented methods further may include identifying an optimal trained model for processing the input audio signal and/or transforming the input audio signal into a transformed audio signal that more closely matches the trained model. Computing devices for converting spoken language into text include a processing unit and a memory that stores non-transitory computer readable instructions that, when executed by the processing unit, cause the computing devices to perform the computer-implemented methods disclosed herein.

### RELATED APPLICATION

This application claims priority to U.S. Provisional Patent Application No. 62/682,064, entitled NETWORK-CONNECTED COMPUTING DEVICES AND METHODS FOR CONVERTING AUDIO SIGNALS TO TEXT and filed on Jun. 7, 2018, the complete disclosure of which is incorporated herein by reference.

### FIELD

The present disclosure relates to computing devices and methods for converting audio signals to text.

### BACKGROUND

Automatic Speech Recognition (ASR) systems identify portions of input audio signals that correspond to spoken language and translate the identified spoken language into computer-generated text. ASR systems generally may be characterized as speaker-dependent systems or speaker-independent systems. Speaker-dependent systems use the known speech characteristics of a specific user to transcribe spoken language uttered by the specific user. This type of ASR system is highly accurate; however, such systems require an initial speaker training to be conducted so that the system can determine the speech characteristics of the specific user. Speaker training generally involves an individual speaker reciting a known text or isolated vocabulary, which the speaker-dependent system analyzes and fine-tunes, thus ensuring the system's ability to recognize the individual speaker's unique speech characteristics.

Conversely, speaker-independent systems are not tailored to a single speaker and do not require individual speakers to go through an initial speaker training. However, because speaker-independent systems apply speech translation rules that apply generally to all speakers, and are not calibrated to an individual speaker's unique speech characteristics, they are inherently more inaccurate than speaker-dependent systems. This is problematic in situations where the accuracy of a spoken language translation is important, but where there are no opportunities to conduct initial speaker trainings before the ASR system performs the translation. For example, this problem arises in the field of closed captioning. Generally, closed captioning systems are able to overcome the current problems of speaker-independent systems in accurately transcribing spoken words from a diversity of speakers by hiring human captioners to parrot or re-speak the voices in broadcast content. These re-speakers are called voicewriters. However, the availability of trained voicewriters is limited, especially during emergencies, and life and death information can go uncaptioned. Live content, and especially unexpected live content such as emergency transmissions, can be difficult for human translators to transcribe in real time. Thus, it is desired to develop a speaker-independent ASR system that can quickly and accurately transcribe emergency and other time-sensitive transmissions to ensure that closed captions can be generated and distributed to a hearing-impaired audience.

### SUMMARY

Computer-implemented methods and computing devices for converting spoken language into text are disclosed herein. Computer-implemented methods for converting spoken language into text include receiving an input audio signal that includes spoken language uttered by a speaker and analyzing the input audio signal. The analyzing the input audio signal may include comparing, with a computing device, one or more measured formant values to one or more model formant values. Each of the one or more measured formant values may correspond to a respective measured formant component of one or more measured formant components of an individual phoneme in the input audio signal. Each of the one or more model formant values may correspond to a respective model formant component of one or more model formant components of the individual phoneme in a trained model of an automatic speech recognition (ASR) application. The computer-implemented methods further include determining, with the computing device, one or more differences between the one or more measured formant values and the one or more model formant values. In some embodiments, the computer-implemented methods further include identifying, based on the one or more differences, an optimal trained model for processing the input audio signal with the ASR application. In some embodiments, the computer-implemented methods further include transforming the input audio signal into a transformed audio signal that more closely matches the trained model by applying one or more transformations to the input audio signal.

Computing devices for converting spoken language into text include a processing unit and a memory that stores non-transitory computer readable instructions that, when executed by the processing unit, cause the computing devices to perform the computer-implemented methods disclosed herein.

This Summary is provided to introduce a selection of aspects of the present disclosure in a simplified form that is further described in more detail below in the Description. This Summary is not intended to limit the scope of the claimed subject matter or to identify features that are essential to the claimed subject matter.

### BRIEF DESCRIPTION OF THE DRAWINGS

FIG. 1 is a schematic illustration representing example environments and processes that may be utilized in computer-implemented techniques for transcribing spoken language in an input audio signal into a computer-generated text according to the present disclosure.

FIG. 2 is a schematic illustration representing example systems for transcribing spoken language in an input audio signal into a computer-generated text according to the present disclosure.

FIG. 3 is an illustration representing an example spectrogram of an input audio signal according to the present disclosure.

FIG. 4 is an example formant graph illustrating distributions of speech characteristics across a population of speakers according to the present disclosure.

FIG. 5 is a set of tables representing example speech characteristics for the input audio signal and model speakers according to the present disclosure.

FIG. 6 is a flowchart depicting examples of methods for transcribing spoken language in an input audio signal into a computer-generated text according to the present disclosure.

### DESCRIPTION

This application describes computing devices and computer-implemented techniques that represent technological improvements in the technical field of converting spoken language into computer-generated text. By utilizing these techniques, the accuracy with which computing devices can accurately generate textual transcriptions of spoken language included in an input audio signal is enhanced irrespective of the speaker of the spoken language. More specifically, the computing devices and computer-implemented techniques include a specific set of computing processes by which a computing device preprocesses input audio signals so that spoken language can be more accurately transcribed by a speaker-independent automatic speech recognition (ASR) application. In some examples, and as described herein, the computing device analyzes the input audio signal and performs transformations on the input audio signal such that the audio signal more closely matches the speech characteristics of one of the model speakers, thereby enabling a speaker-dependent ASR application to more accurately transcribe spoken language of an unknown speaker within an input audio signal. In some examples, and as described herein, the computing device analyzes the input audio signal and identifies a matching trained model of a plurality of distinct trained models associated with a speaker-dependent ASR application that most closely matches characteristics of the input audio signal, thereby optimizing the transcription accuracy of spoken language of an unknown speaker within an input audio signal. In these manners, by use of the techniques, computing devices are able to utilize speaker-dependent ASR applications to perform as de facto speaker-independent ASR systems that more accurately transcribe spoken language from any speaker, and enable the computing device to perform transcription tasks that could previously only be accomplished by human translators. Additionally, the computing devices and computer-implemented techniques are able to provide these improvements in transcription accuracy while requiring drastically lower processing power and memory storage than currently is required by speaker-independent ASR systems.

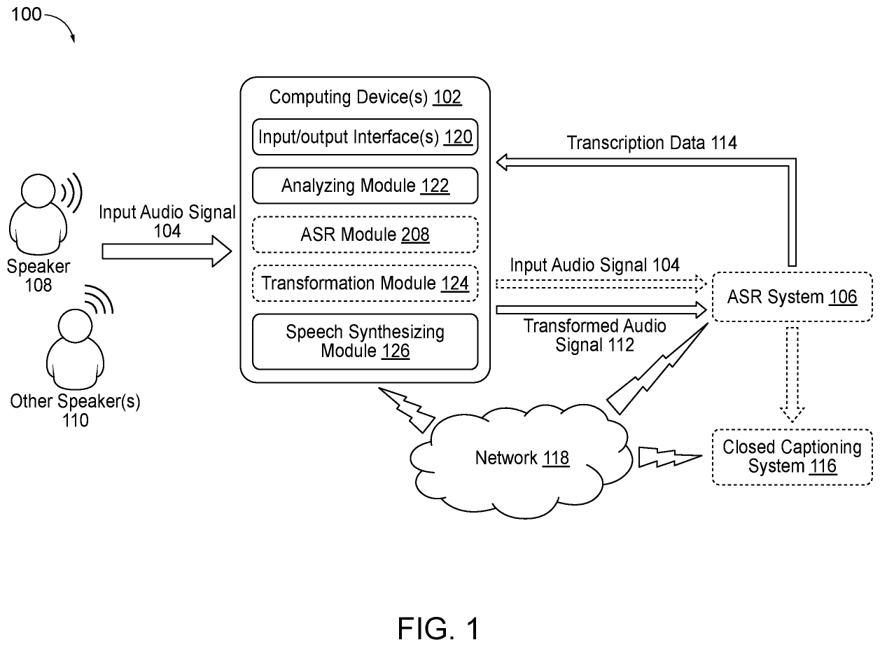

FIGS. 1-6 provide illustrative, non-exclusive examples of computing environments 100, of computing devices 102, of systems 200, and/or of computer-implemented methods 600 for converting spoken language in input audio signals into computer-generated text. In general, in the drawings, elements that are likely to be included in a given embodiment are illustrated in solid lines, while elements that are optional or alternatives are illustrated in dashed lines. However, elements that are illustrated in solid lines are not essential to all embodiments of the present disclosure, and an element shown in solid lines may be omitted from a particular embodiment without departing from the scope of the present disclosure. Elements that serve a similar, or at least substantially similar, purpose are labelled with numbers consistent among the figures. Like numbers in each of the figures, and the corresponding elements, may not be discussed in detail herein with reference to each of the figures. Similarly, all elements may not be labelled or shown in each of the figures, but reference numerals associated therewith may be used for consistency. Elements, components, and/or features that are discussed with reference to one or more of the figures may be included in and/or utilized with any of the figures without departing from the scope of the present disclosure.

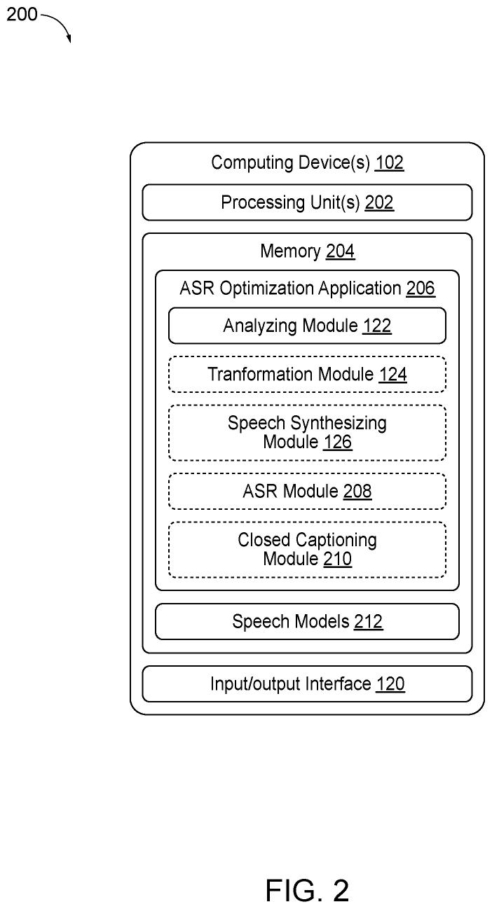

FIGS. 1-2 schematically illustrate examples of environments, components, interfaces, and processes according to the present disclosure. More specifically, FIG. 1 is a schematic drawing of example environments 100 that illustrate example computing environments, computing devices, and computer-implemented processes for transcribing spoken language in an input audio signal into a computer-generated text, while FIG. 2 schematically illustrates an example system 200 for transcribing spoken language in an input audio signal 104 into a computer-generated text. Additional details of individual components, operations, and/or processes schematically illustrated in FIGS. 1-2 and discussed below are described in more detail with reference to subsequent figures.

As shown in FIG. 1, the environment 100 includes at least one computing device 102 that is configured to analyze an input audio signal 104 and/or to perform transformations on the input audio signal 104. For example, input audio signal 104 may include spoken language uttered by speaker 108 and/or by one or more other speakers 110, and the computing device 102 may perform one or more operations on the input audio signal 104 to optimize transcription of the input audio signal 104 into text, as described herein. As discussed in more detail below, such operations generally include comparing characteristics of the input audio signal 104 with speech characteristics of one or more model speakers (such as may correspond to an ASR program), and further may include generating a transformed audio signal 112 that more closely matches the speech characteristics of the model speaker(s).

Environments 100 generally include an ASR program that is configured to transcribe the spoken language included in audio signals. As examples, and as described herein, the ASR program may receive data corresponding to an input audio signal 104 and/or a transformed audio signal 112, and may generate and output transcription data 114 that corresponds to the textual transcription of spoken language included in the input audio signal 104 and/or the transformed audio signal 112. As used herein, the ASR program also may be referred to as an ASR application.

The ASR program may include, utilize, and/or be any appropriate process or method for recognizing speech in the input audio signal 104 and/or generating the output transcription data 114.

For example, and as described herein, the ASR program may be a speaker-dependent ASR program that utilizes the known speech characteristics of a specific speaker to transcribe spoken language uttered by the specific speaker. As used herein, the specific speaker generally may be referred to as a model speaker corresponding to the ASR program, and/or the ASR program may be described as being trained by the model speaker. As used herein, the model speaker may be described as representing and/or corresponding to speech model data associated with the ASR program. Alternatively, or in addition, the model speaker may be described as representing and/or corresponding to a trained model associated with the ASR program. Stated differently, as used herein, the model speaker also may be referred to as the trained model, and vice versa. It is within the scope of the present disclosure that the ASR program and/or the model data may include data corresponding to a single model speaker/training model, or may include data corresponding to a plurality of unique model speakers/training models. For example, the speech model data may include training models associated with each of a plurality of distinct model speakers. Moreover, it is within the scope of the present disclosure that the ASR program may be configured to dynamically adjust and/or expand upon the set of model speakers/training models associated therewith, such as by identifying and recording speech characteristics associated with newly identified speakers, as described herein.

The ASR program may be incorporated into environment 100 and/or computing device 102 in any appropriate manner. In some embodiments, the ASR program may be an ASR module executing on computing device 102, an ASR system that is separate from computing device 102, or both. For example,

FIG. 1 depicts environment 100 as including an ASR module 208 as a software module of computing device 102 and/or as including an ASR system 106 that is separate from computing device 102. That is, while FIG. 1 illustrates ASR system 106 as being separate from computing device 102, this is not required, and it is within the scope of the present disclosure that ASR system 106 and/or ASR module 208 may refer to any appropriate embodiment and/or instantiation of the ASR program, regardless of the specific hardware and/or software running the ASR program. FIG. 1 further shows environment 100 as optionally including a closed captioning system 116 that is configured to convert transcription data 114 into closed captioning data and/or to generate a media signal having closed captioning data.

According to the present disclosure, computing device 102, ASR system 106, and/or closed captioning system 116 (when present) may correspond to one or more electronic devices having computing capabilities. For example, computing device 102, ASR system 106, and/or closed captioning system 116 individually or collectively may include many different types of electronic devices, including but not limited to a personal computer, a laptop computer, a tablet computer, a computing appliance (e.g., a router, gateway, switch, bridge, repeater, hub, protocol converter, etc.), a smart appliance, a smart speaker, an internet-of-things device, a portable digital assistant (PDA), a smartphone, a wearable computing device, an electronic book reader, a game console, a set-top box, a smart television, a portable game player, a portable media player, a server, and so forth.

As illustrated in FIG. 1, the ASR system 106 and/or closed captioning system 116 may be separate computing devices that are in communication with the computing device 102 via network 118. Examples of network 118 include the Internet, a wide area network, a local area network, or a combination thereof. Network 118 may be a wired network, a wireless network, or both. Alternatively, in some embodiments according to the present disclosure, one or both of the ASR system 106 and the closed captioning system 116 may be partially or completely included in a combined computing device, such as computing device 102. For example, and as schematically illustrated in FIG. 1, the ASR program may correspond to, include, and/or be an ASR module 208 executed on the computing device 102.

FIG. 1 further illustrates computing device 102 as including at least one input output (I/O) interface 120 and hosting an analyzing module 122 and a transformation module 124. Generally, program modules include routines, programs, objects, components, data structures, etc., and define operating logic for performing particular tasks or implementing particular abstract data types. As used herein, the term “module,” when used in connection with software or firmware functionality, may refer to code or computer program instructions that are integrated to varying degrees with the code or computer program instructions of other such “modules.” The distinct nature of the different modules described and depicted herein is used for explanatory purposes and should not be used to limit the scope of this disclosure.

The at least one I/O interface 120 may include any interface configured to allow the computing device 102 to receive and/or transmit data, such as a network interface, a wired interface, a microphone, a CD/DVD drive, and/or an interface for receiving/transforming a physical recording of the spoken language into a digital signal. For example, the at least one I/O interfaces 120 may include a microphone configured to detect sound waves in environment 100 and to convert the sound waves into a digital waveform signal. Alternatively, or in addition, the at least one I/O interfaces 120 may include a network interface that allows data including the input audio signal 104 to be transmitted between the computing device 102, the ASR system 106, the closed captioning system 116, and/or other computing devices. In some embodiments, the at least one I/O interfaces 120 may include an interface for reading a physical or digital recording of an input audio signal 104, such as an HDMI port, a CD/DVD drive, etc.

The analyzing module 122 is configured to cause the computing device 102 to analyze the input audio signal 104. For example, analyzing the input audio signal 104 may comprise identifying a portion of the input audio signal 104 that corresponds to an individual phoneme uttered by the speaker 108. According to the present disclosure, a phoneme is an abstraction of physical speech sounds that may be identified independent of the spoken language. There are at least 44 phonemes in the English language, with each phoneme representing a different sound a speaker might make when uttering spoken language in the English language. As an example, the English word “chef” can be broken down into the phonemes “/∫/,” “/e/,” and “/f/.”

In some embodiments, the input audio signal 104 comprises a digital waveform pattern, and the analyzing module 122 identifies the portion of the input audio signal 104 that corresponds to an individual phoneme by identifying a portion of the digital waveform (e.g., an interval in time) that includes characteristics indicative of an utterance of the individual phoneme. The digital waveform pattern may include and/or be represented in any appropriate manner, and/or may indicate the component frequencies within the input audio signal 104 over time. Example digital waveform patterns include a spectrograph, spectral waterfall, a spectral plot, voiceprint, a voicegram, etc.

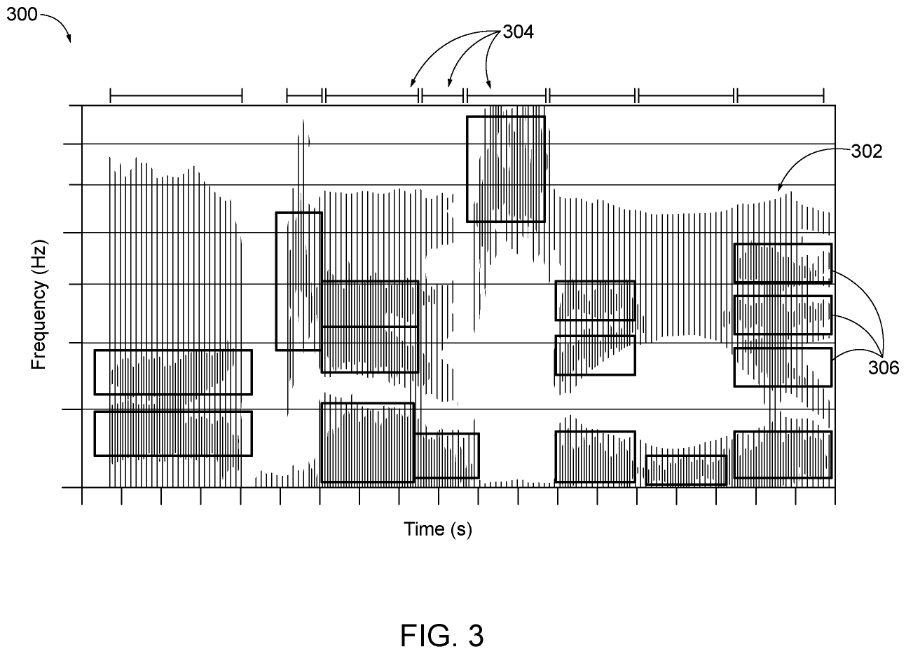

FIG. 3 illustrates an example of a digital waveform pattern in the form of a spectrogram 300, such as may correspond to the input audio signal 104. More specifically, spectrogram 300 displays the frequencies present in an example input audio signal 302 (such as may correspond to and/or be the input audio signal 104), with the relative local density of the plot generally indicating the relative amplitudes of the frequency components of the input audio signal 302. As illustrated in FIG. 3, input audio signal 302 may be partitioned into time intervals 304 that correspond to distinct phonemes present in the input audio signal 302.

With reference to FIG. 3, the input audio signal 302 and/or the time intervals 304 corresponding to distinct phonemes may be characterized in terms of the predominant frequency components within the input audio signal 302. Examples of such predominant frequency components are indicated with rectangular windows in FIG. 3, and generally are described as representing and/or corresponding to formants of the corresponding phoneme. For example, as illustrated in FIG. 3, the input audio signal 302 and/or a given phoneme therein may be characterized by a corresponding set of formant components 306.

A formant may be described as a concentration of acoustic energy localized about a particular frequency component of an audio signal associated with speech of a complex sound. As used herein, a formant may be described and/or characterized by one or more of a frequency of an amplitude peak, a resonance frequency maximum, a spectral maximum, a bounding frequency(ies), and/or a range of frequencies of a complex sound in which there is an absolute or relative maximum in the sound spectrum. More specifically, as used herein, the term “formant” generally refers to a concentration of acoustic energy/relative amplitude in the frequency domain (e.g., the portions of the spectrogram 300 contained within each rectangular window), and the frequency(ies) associated with the formant generally are referred to as the “formant value(s).” Moreover, the set of formants associated with a given phoneme generally are referred to in order of ascending corresponding formant values. Thus, for example, the formant with the lowest corresponding formant value of a set of formants corresponding to a given phoneme generally is referred to as the “first formant” of the phoneme, the formant with the second lowest corresponding formant value of the set of formants generally is referred to as the “second formant” of the phoneme, and so forth.

As shown in FIG. 3, each individual phoneme present in the input audio signal 302 may be substantially and/or completely characterized and/or identified by the formant components 306 associated with the phoneme and/or the corresponding formant values. In this sense, identification of the set of formant values corresponding to the phoneme may be used to identify the phoneme itself, which in turn may be used to transcribe the input audio signal 302 into text. For example, the analyzing module 122 may determine that a portion of the digital waveform corresponding to the input audio signal 104 includes a pattern of one or more formants that matches and/or is similar to the pattern of formants that are expected for a recording of an utterance of the individual phoneme. In some embodiments, when making this determination, the analyzing module 122 may access phoneme data that describes patterns of formants and/or frequencies of formants that are expected to be present in waveform recordings of corresponding phonemes. Accordingly, the accuracy of the transcription of the input audio signal 302 into text is at least partially based upon the fidelity by which the set of formant values is associated (e.g., by the ASR system 106) with the corresponding phoneme.

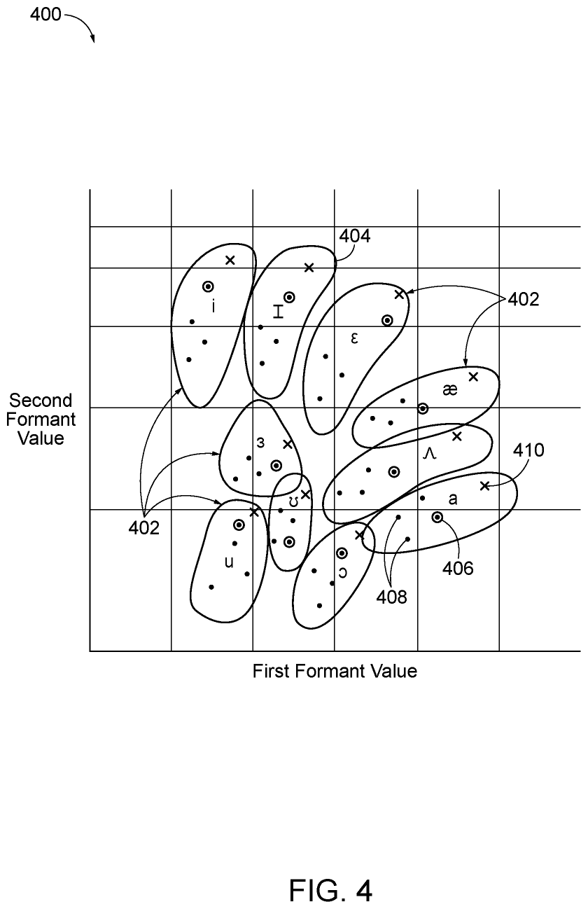

A challenge in the task of transcribing speech to text arises from the fact that different speakers generally produce correspondingly distinct sets of formant values corresponding to the formant components of a given phoneme. That is, while different speakers generally produce formant values (e.g., corresponding to each of at least the first formant and the second formant) that are roughly consistent when uttering a given phoneme, distinctions among a population of speakers such as anatomical differences, accents, dialects and the like yield distributions in these formant values across the population. As a demonstration of this phenomenon, FIG. 4 illustrates an example of a formant graph 400 showing a distribution of speech characteristics across a population of speakers. Specifically, graph 400 shows a collection of distributions 402 of speech characteristics across a population of speakers, with each collection 402 representing data points grouped according to a corresponding phoneme. That is, each data point represents a pair of formant values corresponding to the first formant and the second formant measured when the speaker utters the corresponding phoneme. In this manner, FIG. 4 may be described as displaying formant component-phoneme relationships for each of a plurality of speakers and a plurality of phonemes. For example, distribution 404 corresponds to the phoneme “I,” with the data points therein illustrating the formant values produced when each member of the population of speakers utters the phoneme.

As shown in FIG. 4, each data point 406 corresponds to an average speech characteristic associated with each phoneme (e.g. among the population of speakers for the given phoneme); each data point 408 respectively represents the speech characteristics of a distinct speaker; and each data point 410 represents the speech characteristics of a model speaker. Thus, for example, an analysis of an utterance produced by an arbitrary speaker may include and/or be represented as identifying which distribution 402, which averaged data point 406, and/or which model data point 410 most closely matches the data point 408 corresponding to the utterance and thereby identifying which phoneme distribution 402 the data point 408 most likely belongs to. Repeating this process for each phoneme in a series of individual phonemes in the input audio signal 104 thus yields a series of measured phonemes corresponding to the spoken language, which then may be processed and/or transcribed into a textual representation of the spoken language.

With reference to FIG. 4, and as described in more detail herein, the systems and processes of the present application generally may be understood as transforming an input audio signal such that the input audio signal 104 (such as may correspond to a given data point 408) more closely matches a model speech characteristic (such as may correspond to a model data point 410), and/or as identifying which of a plurality of trained models (such as may correspond to distinct model data points 410 for a given phoneme distribution 402) most closely matches the input audio signal 104.

To characterize the input audio signal 104, the analyzing module 122 generally identifies one or more measured formant values corresponding to one or more measured formant components of an identified phoneme. For example, the analyzing module 122 may identify a first measured formant value for a first formant component of the portion of the input audio signal 104 that corresponds to an individual phoneme. The analyzing module 122 also may identify a second measured formant value for a second formant component of the portion of the input audio signal 104 that corresponds to the individual phoneme. In some embodiments, and as discussed, the first formant component and the second formant component respectively correspond to the lowest frequency formant component and the second-lowest frequency formant component of the portion of the input audio signal 104. In various embodiments, the analyzing module 122 repeats this process for one or more additional formants in the input audio signal 104 (e.g., a third formant, a fourth formant, etc.).

The analyzing module 122 also may be configured to compare the portions of the input audio signal 104 that correspond to an individual phoneme to speech characteristics of each of one or more model speakers that previously were used to train ASR system 106. For example, ASR system 106 may be a speaker-dependent ASR system that includes stored speech data regarding formant component-phoneme relationships for each of one or more model speakers, such that the ASR system is specifically configured to recognize and/or transcribe the speech of each of the one or more model speakers. Accordingly, when the speaker 108 who produces input audio signal 104 is not a model speaker for which ASR system 106 was previously trained, the analyzing module 122 generally is configured to compare formant characteristics of the input audio signal 104 to corresponding formant characteristics as uttered by the model speaker(s), such that a speaker-dependent ASR system may be utilized to recognize the speech of a previously unknown speaker.

In some embodiments, the analyzing module 122 accesses model data that identifies characteristics of speech for a model speaker that was used to train an ASR application, where the characteristics of speech include information relating to the expected formant components of individual phonemes when uttered by the model speaker. For example, the model data may identify a first model formant value for a first formant component of an utterance of the individual phoneme by the model speaker and a second model formant value for a second formant component of the utterance of the individual phoneme by the model speaker. In an example embodiment, the first model formant value is a frequency associated with the lowest frequency formant component (i.e., the first formant) of the particular phoneme, and the second model formant value is a frequency associated with the second lowest frequency formant component (i.e., the second formant) of the particular phoneme.

In some embodiments, comparing the portions of the input audio signal 104 to the speech characteristics of the model speaker(s) includes the analyzing module 122 comparing the first measured formant value, the second measured formant value, and/or higher measured formant values with the first model formant value, the second model formant value, and/or higher model formant values corresponding to a given model speaker. The comparison may include a comparison of frequencies of the measured formant values and the model formant values; an analysis of the formants on a formant graph, such as similar to the graph illustrated in FIG. 4; and/or another type of logical, mathematical, and/or statistical analysis. For example, the analyzing module 122 may determine one or more differences between the one or more measured formant values and one or more model formant values. As a more specific example, the analyzing module 122 may determine one or more differences between the first measured formant value and the first model formant value, between the second measured formant value and the second model formant value, and/or between higher corresponding measured and model formant values.

In some embodiments, the analyzing module 122 is configured to repeat one or more of these processes for additional portions of the input audio signal 104 that correspond to other phonemes. In some embodiments, the analyzing module 122 additionally or alternatively may be configured to determine one or more differences among the measured formant values (e.g., between two or more of the first measured formant value, the second measured formant value, the third measured formant value, etc.) and/or among the model formant values (e.g., between two or more of the first model formant value, the second model formant value, the third model formant value, etc.).

While the present disclosure generally describes examples in which the analyzing module 122 evaluates one or more lowest-frequency formant components of the individual phoneme (i.e., the first formant; the first formant and the second formant; the first, second, and third formants; etc.), this is not necessary. For example, it is additionally within the scope of the present disclosure that the one or more formant components evaluated for a given phoneme form any appropriate subset of the full set of formant components of the given phoneme, including subsets that include non-consecutive formant components and/or subsets that do not include the first formant component.

As used herein, determining a difference between two or more formant values may include comparing the formant values in any appropriate manner. As examples, determining a difference between a pair of formant values may include calculating an arithmetic difference between the formant values (e.g. via a subtraction operation), calculating a ratio and/or a percentage difference between the formant values (e.g. via a division operation), and/or any other appropriate mathematical and/or quantitative comparison of the formant values.

In some embodiments, the transformation module 124 is configured to cause the computing device 102 to apply and/or perform one or more transformations on the input audio signal 104. In some embodiments, the transformation module 124 performing the one or more transformations includes and/or results in the generation of transformed audio signal 112 that more closely matches the speech characteristics of a model (e.g., a model speaker) that previously was used to train ASR system 106. In some embodiments, the one or more transformations include performing a mathematical transformation on the input audio signal 104 based on the one or more differences between the one or more measured formant values and the one or more model formant values.

The mathematical transformation may include and/or be any appropriate transformation, such as may be known to the art of signal processing. For example, the transformation may correspond to the transformation module 124 applying a Hilbert transform to some or all of the input audio signal 104. Additionally or alternatively, the one or more transformations may include modifying the input audio signal 104 such that the formant values corresponding to the formant components of each of one or more phonemes in the input audio signal 104 more closely match the corresponding formant values associated with a model speaker that previously was used to train the ASR system 106. For example, in an example in which the frequencies of the first and second measured formant values each are 15% lower than the corresponding model formant values, the transformation module 124 may apply a transformation to the input audio signal 104 to proportionally increase the frequency components in the input audio signal 104 (e.g., by 15%) so that they more closely match the speech characteristics of the model. As another example in which the frequencies of the first and second measured formant values each are on average 100 Hz lower than the corresponding model formant values, the transformation module 124 may apply a transformation to the input audio signal 104 to additively increase the frequency components in the input audio signal 104 (e.g., by 100 Hz) so that they more closely match the speech characteristics of the model. In other examples, the transformation module 124 may apply any appropriate combination of additive and/or proportional transformations to the frequency components of the input audio signal 104 so that they more closely match the speech characteristics of the model.

In various embodiments, transformations correspond to the transformation module 124 applying a blanket transformation to the entire input audio signal 104, applying a transformation to the portions of the input audio signal 104 that correspond to the individual phoneme, or applying a transformation to portions of the input audio signal 104 that correspond to a set of phonemes that are related to the individual phoneme. In this manner, transforming the formant characteristics of the input audio signal 104 may produce a transformed audio signal 112 with formant characteristics that more closely match those of a model speaker that previously was used to train ASR system 106. Thus, providing the transformed audio signal 112 to the ASR system 106 enables the ASR system 106 to recognize and/or transcribe the speech corresponding to input audio signal 104 with greater fidelity than if the original input audio signal 104 had been provided to the ASR system 106.

In some embodiments, comparing the portions of the input audio signal 104 to the speech characteristics of the model speaker(s) includes the analyzing module 122 comparing the first measured formant value, the second measured formant value, and/or higher measured formant values with the first model formant value, the second model formant value, and/or higher model formant values corresponding to each of a plurality of model speakers. The comparison may include a comparison of frequencies of the measured formant values and the model formant values for each of the plurality of model speakers; an analysis of the formants on a formant graph, such as similar to the graph illustrated in FIG. 4; and/or another type of logical, mathematical, and/or statistical analysis. For example, for each of the plurality of model speakers, the analyzing module 122 may determine one or more differences between the first measured formant value and the first model formant value, between the second measured formant value and the second model formant value, and/or between higher corresponding measured and model formant values. In some embodiments, the analyzing module 122 is configured to repeat one or more of these processes for additional portions of the input audio signal 104 that correspond to other phonemes, for each of the plurality of model speakers. Such embodiments may not include transformation module 124 generating transformed audio signal 112. Rather, such embodiments may include identifying, based upon the comparison of the formant characteristics of the input audio signal and of each of the plurality of model speakers, an optimal model speaker of the plurality of model speakers that exhibits and/or corresponds to formant characteristics that most closely match those of the input audio signal 104. In this manner, the ASR system 106 subsequently may be configured to recognize and/or transcribe the input audio signal 104 as though the optimal model speaker had produced the input audio signal 104. Stated differently, the ASR system 106 subsequently may be configured to recognize and/or transcribe the input audio signal 104 in accordance with the formant component-phoneme relationships associated with the optimal model speaker. In this manner, a speaker-dependent ASR system that was trained with a plurality of model speakers may be selectively and dynamically configured to analyze the input audio signal 104 in accordance with a model speaker that most closely matches the speech characteristics of the input audio signal 104. In this manner, such a method enables increasing the fidelity of the recognition and/or transcription of the input audio signal 104 relative to an example in which the input audio signal 104 is analyzed in accordance with a randomly-selected model speaker of a speaker-dependent ASR system. As used herein, reference to the ASR system 106 (or an analogous application) processing an audio signal in accordance with a given model speaker generally refers to the ASR utilizing speech data corresponding to the given model speaker to detect and/or identify the phonemes in the audio signal.

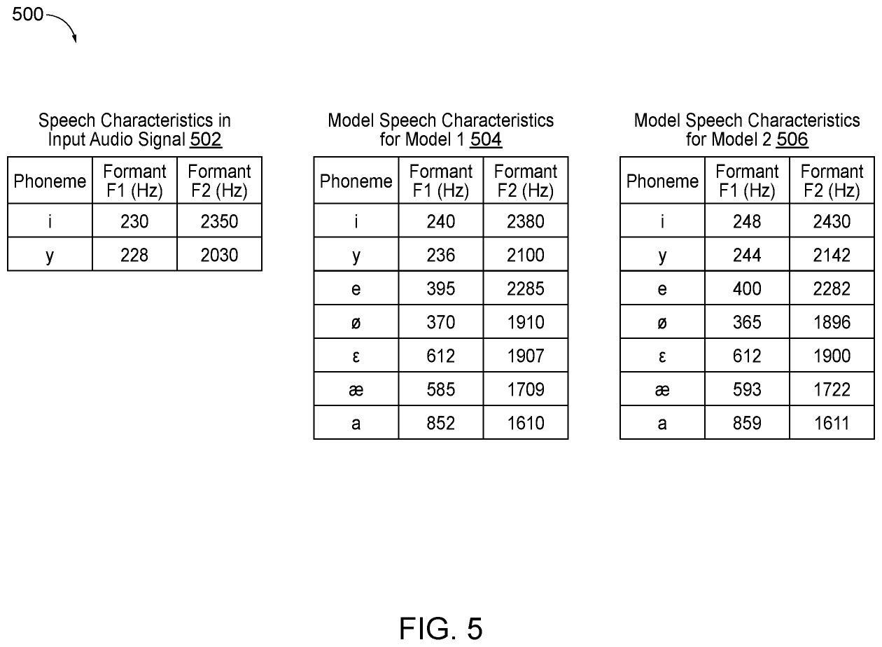

FIG. 5 displays a set of tables 500 showing example speech characteristics for the input audio signal 104 as well as for two distinct model speakers, such as may be utilized to determine which model speaker most closely matches the input audio signal 104. Specifically, FIG. 5 shows a first table 502 that indicates speech characteristics as measured in an input audio signal 104, a second table 504 that indicates speech characteristics of a first model speaker, and a third table 506 that indicates speech characteristics of a second model speaker. More specifically, each of the first table 502, the second table 504, and the third table 506 indicates formant values corresponding to the first formant component F1 and the second formant component F2 for each of a plurality of distinct phonemes. As seen in FIG. 5, for each of the two phonemes recorded in the input audio signal 104, the first model speaker exhibits the smallest differences between the formant values for F1 and F2 and to the corresponding formant values measured in the input audio signal 104, while the second model speaker exhibits larger differences. Thus, in the example of FIG. 5, a comparison of the formant values measured in the input audio signal 104 to the formant values corresponding to each of the two model speakers may result in the identification of the first model speaker as the optimal model speaker.

In an example in which the transformation module 124 generates the transformed audio signal 112, the computing device 102 also may be configured to refine the transformed audio signal 112 and/or the transformations applied to the input audio signal 104 based on feedback from the ASR system 106. In some embodiments, the computing device 102 refines the transformed audio signal 112 and/or the transformations applied to the input audio signal 104 based on transcription data 114 received from the ASR system 106, where the transcription data 114 corresponds to a textual transcription of spoken language in the input audio signal 104. For example, the computing device 102 may compare the input audio signal 104 with the textual transcription of the spoken language in the input audio signal and/or to a synthesized audio signal corresponding to the textual transcription to determine the speech characteristics of the speaker and/or the fidelity of the textual transcription. The results of such a comparison then may be used to train the ASR program and/or to modify the transformations applied to the input audio signal 104.

As an example, and as schematically illustrated in FIG. 1, environment 100 and/or computing device 102 optionally may include a speech synthesizing module 126. The speech synthesizing module 126 may be configured to receive transcription data 114 corresponding to a textual transcription of spoken language included in the input audio signal 104 and to generate a synthesized audio signal corresponding to an utterance of the spoken language in the textual transcription. The computing device 102 then may compare the synthesized audio signal to the input audio signal 104 in such a manner that the comparison may be utilized to refine the transformed audio signal 112 and/or the transformations applied to the input audio signal 104. Such a comparison may be performed in any appropriate manner, such as by comparing the waveforms and/or the frequency spectra of the input audio signal 104 and the synthesized audio signal.

Similarly, in an example in which the ASR system 106 recognizes and/or transcribes the input audio signal 104 in accordance with an optimal model speaker of a plurality of model speakers, the computing device 102 also may be configured to refine the selection of the optimal model speaker based on feedback from the ASR system 106. For example, the ASR system 106 may generate transcription data 114 corresponding to a textual transcription of spoken language in the input audio signal 104 as transcribed in accordance with the selected optimal model speaker, and the computing device 102 may compare the input audio signal 104 with the textual transcription and/or to a corresponding audio signal. More specifically, computing device 102 may utilize the speech synthesizing module 126 to generate a synthesized audio signal corresponding to an utterance of the spoken language in the textual transcription, and the computing device 102 then may compare the synthesized audio signal to the input audio signal 104 in such a manner that the comparison may be utilized to revise the selection of the optimal model speaker utilized by the ASR system 106. As a more specific example, such a feedback process may be repeated for each of a plurality of model speakers, and the optimal model speaker may be identified as the model speaker for which the input audio signal 104 is most similar to the synthesized audio signal corresponding to the textual transcription of the input audio signal 104.

FIG. 1 further illustrates an example of a process that may be utilized to transcribe spoken language in an input audio signal 104 into computer-generated text. This process may be initiated by the computing device 102 receiving the input audio signal 104. As discussed above, the input audio signal 104 is received via an I/O interface 120. In some embodiments, the input audio signal 104 may be received by the I/O interface 120 as a digital signal. Alternatively, the input audio signal 104 may be received in a different form (such as an analog signal, a physical recording, a sound wave, etc.) and converted by the computing device 102 into a digital signal.

As discussed above, the computing device then may analyze the input audio signal 104 and perform one or more transformations to input audio signal 104 that generate a transformed audio signal 112 that more closely matches a model speaker used to train the ASR system 106. The computing device 102 then may transmit transformed audio signal 112 to the ASR system 106. During the period of time between when the input audio signal 104 is received by the computing device 102 and the time that the transformed audio signal 112 is transmitted to the ASR system 106, the computing device 102 may optionally transmit the input audio signal 104 to the ASR system 106. In this way, the ASR system 106 is able to use the input audio signal 104 to generate transcription data 114 for the spoken language in the input audio signal 104 during the time period when the computing device 102 is initially analyzing and transforming the input audio signal 104.

The ASR system 106 generates transcription data that corresponds to a textual transcription of spoken language included in the input audio signal 104. As shown in FIG. 1, the ASR system 106 then transmits the transcription data 114 to the computing device 102. As discussed above, the computing device 102 may use the transcription data 114 to refine the transformed audio signal 112, the transformations applied to the input audio signal 104, and/or the selection of the optimal model speaker for transcribing the input audio signal 104. In an example that includes generating the transformed audio signal 112, because the transformed audio signal 112 more closely matches a model speaker that was used to train the ASR system 106, the textual transcription generated by the ASR system 106 is more accurate than if the ASR system 106 had generated transcription data for the input audio signal 104. Similarly, in an example that includes identifying an optimal model speaker for transcribing the input audio signal 104, the textual transcription generated by the ASR system 106 generally is more accurate than if the input audio signal 104 had been transcribed in accordance with a random and/or arbitrarily selected model speaker. In this way, the invention discussed herein represents a technical improvement in the computing field of audio to text transcription because the described techniques enable ASR programs to more accurately transcribe spoken language uttered by speakers for whom the ASR program has not been previously trained.

The example process illustrated in FIG. 1 further includes an optional step in which the ASR system 106 transmits the transcription data 114 to the optional closed captioning system 116. The closed captioning system 116 then may generate closed captioning data that includes, or indicates, one or more captions that are to be shown in association with portions of a media signal. The closed captioning system 116 may pair the text of the textual transcription of the spoken language with associated video content. For example, the transcription data 114 may include time stamps that indicate a temporal location within the input audio signal 104 corresponding to individual words and/or phonemes within the textual transcription. In such examples, the closed captioning system 116 may use the time stamps to pair portions of the textual transcription with portions of a video signal (e.g., video frames). In this way, where the input audio signal 104 is associated with a live feed, the closed captioning system 116 may generate closed captioning data for live content that previously was only able to be captioned using human voicewriters.

Alternatively, or in addition, the closed captioning system 116 may generate closed captioning data for recorded content. For example, where the input audio signal 104 is associated with an audio portion of recorded content, the closed captioning system 116 may generate closed captioning data for the recorded content. Such captioning data subsequently may be reviewed by human voicewriters, and/or may be refined using one or more of the refinement techniques described above. For example, after generating the closed captioning data with the closed captioning system 116, the computing device 102 may refine the transformations and subsequently transform the input audio signal 104 for the recorded content a second time using the refined transformations. Additionally or alternatively, after generating the closed captioning data with the closed captioning system 116, the computing device 102 may refine the selection of an optimal model speaker for transcribing the input audio signal 104. In this way, the ASR system 106 may generate a refined transcription that more accurately describes the spoken words in the recorded content, and the closed captioning system 116 may generate more accurate closed captions for the recorded content.

In some embodiments, the closed captioning system 116 further is configured to provide an indication regarding when a speaker change occurs within an input audio signal 104 and/or identification of a speaker that produces input audio signal 104. For example, input audio signal 104 may correspond to content that is spoken by a plurality of distinct speakers in turn (such as speaker 108 and/or other speakers 110), and computing device 102 and/or closed captioning system 116 may be configured to detect when (e.g., at what time within input audio signal 104) a change of speaker takes place and to indicate the speaker change within the closed captioning data.

Detecting a speaker change may include utilizing any appropriate analysis technique, such as any of the techniques discussed herein. For example, the analyzing module 122 may be configured to continuously and/or periodically analyze the formant component-phoneme relationships measured in the input audio signal 104, with an abrupt change in such relationships indicating a speaker change. As an example, the analyzing module 122 detecting a substantial shift in the formant values corresponding to the measured formant components of a given phoneme may indicate that the speaker producing the input audio signal 104 has changed, and the closed captioning system 116 may be configured to generate a textual indication within the closed captioning data indicative of the speaker change.

Alternatively, or in addition, the analyzing module 122 may be configured to identify the speaker that is producing the input audio signal 104, and/or the closed captioning system 116 may be configured to generate a textual indication of the identity (e.g., the name) of the speaker that is producing the input audio signal 104. For example, the computing device 102 and/or analyzing module 122 may include stored speech data (such as formant component-phoneme data) corresponding to each of a plurality of expected speakers (such as speaker 108 and/or other speakers 110), and the analyzing module 122 may be configured to identify which of the plurality of expected speakers produced the input audio signal 104 via comparison of the measured formant characteristics of the input audio signal 104 and the stored speech data. As examples, the plurality of expected speakers may include two expected speakers, three expected speakers, four expected speakers, or more than four expected speakers. In such examples, the closed captioning system 116 additionally may be configured to generate a textual indication within the closed captioning data indicative of which speaker of the plurality of expected speakers is speaking, optionally in conjunction with a textual indication of a speaker change, as described above.

In some embodiments, the closed captioning system 116 generates a captioned media signal that includes video content as well as closed captioning data that includes, or indicates, captions that are to be presented in association with individual portions of the video content. The closed captioning system 116 then may distribute the closed captioning data and/or the captioned media signal to one or more customers of the closed captioning system.

As discussed, FIG. 2 is a schematic diagram illustrating examples of system 200 for transcribing spoken language in an input audio signal 104 into a computer-generated text. More specifically, while FIG. 1 illustrates a generalized system and conceptual flow of operations including receiving an input audio signal 104, analyzing the input audio signal 104, applying one or more transformations to the input audio signal 104 to generate a transformed audio signal 112, and/or transmitting the transformed audio signal to an ASR system 106 for transcription into a computer-generated text, FIG. 2 illustrates additional details of hardware and software components that may be utilized to implement such techniques. The system 200 is merely an example, and the techniques described herein are not limited to performance using the system 200 of FIG. 2. Accordingly, any of the details of computing device 102 described or depicted with regard to FIG. 2 may be utilized within environment 100 of FIG. 1, and any of the details described or depicted with regard to computing device 102 within environment 100 of FIG. 1 may be utilized by the computing device 102 of FIG. 2.

According to the present disclosure, computing device 102 may correspond to a personal computer, a laptop computer, a tablet computer, a computing appliance (e.g., a router, gateway, switch, bridge, repeater, hub, protocol converter, etc.), a smart appliance, a server, a switch, an internet-of-things appliance, a portable digital assistant (PDA), a smartphone, a wearable computing device, an electronic book reader, a game console, a set-top box, a smart television, a portable game player, a portable media player, and/or any other type of electronic device. In FIG. 2, the computing device 102 includes one or more (i.e., at least one) processing units 202, memory 204 communicatively coupled to the one or more processing units 202, and an input output (I/O) interface 120.

As discussed above, the I/O interface(s) 120 may include any interface configured to allow the computing device 102 to receive an input audio signal 104. Example interfaces for receiving an input audio signal 104 include both (i) interfaces configured to receive data that includes the input audio signals 104, such as a network interface, a wired interface, an HDMI port, etc., and (ii) interfaces configured to convert physical stimuli and/or physical recordings into data that includes the input audio signal 104, such as a microphone, a CD/DVD drive, an interface for receiving/transforming a physical recording of the spoken language into a digital signal, etc. For example, the at least one I/O interfaces 120 includes a microphone configured to detect sound waves in environment 100 and to convert the sound waves into a digital waveform signal. In another example, the at least one I/O interfaces 120 may include a wireless and/or Bluetooth® network interface that allows data including the input audio signal 104 to be wirelessly transmitted to the computing device 102 from another computing device. In some embodiments, the at least one I/O interfaces 120 includes an interface for reading a physical or digital recording of an input audio signal 104, such as an HDMI port, a CD/DVD drive, etc.

The at least one I/O interfaces 120 also may include any interface configured to allow data to be transmitted over a wired connection and/or a wireless connection between the computing device 102, the ASR system 106, the optional closed captioning system 116, and/or other computing devices. For example, the at least one I/O interfaces 120 may include a wireless network interface that allows the computing device 102 to transmit the input audio signal 104, the transformed audio signal 112, or both to another computing device via a network 118, such as the Internet.

According to the present invention, the computing device 102 may include an ASR optimization application 206 that is configured to improve the accuracy of audio to text transcriptions for spoken language uttered by previously unknown speakers, as described herein. For example, the ASR optimization application 206 may include and/or be a computing application that is executable to cause the computing device 102 to analyze an input audio signal 104 containing spoken language uttered by a speaker, such as to measure the formant characteristics of the input audio signal 104. In some embodiments, the ASR optimization application 206 also includes an ASR program that generates transcription data 114 that corresponds to a textual transcription of spoken language included in the input audio signal 104, converts the transcription data 114 into closed captioning data, and/or generates a media signal having closed captioning data.

In some embodiments, and as described herein, the ASR optimization application 206 is configured to utilize the measured formant characteristics to transform the input audio signal 104 into a transformed audio signal 112 that more closely matches the speech characteristics of a model speaker used to train an ASR program. In such embodiments, because the transformed audio signal 112 more closely matches a model speaker that was used to train the ASR program, the textual transcriptions generated by the ASR program are more accurate than if the ASR program had generated the transcription data for the un-transformed input audio signal 104. In some embodiments, and as described herein, the ASR optimization application 206 is configured to utilize the measured formant characteristics to select an optimal model speaker of a plurality of model speakers with speech characteristics that most closely match those of the input audio signal 104. In such embodiments, the textual transcriptions generated by the ASR program generally are more accurate than if the input audio signal had been transcribed in accordance with a random and/or arbitrarily selected model speaker. Thus, in such embodiments, the ASR optimization application 206 represents a technical improvement in the computing field of audio to text transcription by enabling ASR programs to more accurately transcribe spoken language uttered by speakers for whom the ASR program has not been previously trained.

FIG. 2 also shows speech model data 212 stored on the memory. The speech model data 212 correspond to a data store that includes, or indicates, speech characteristics of one or more model speakers that were used to train an ASR program (i.e., ASR system 106, ASR module 208, or both). Speech characteristics may include the patterns of formants captured when the model speaker uttered individual phonemes, and/or the formant values of the formant components corresponding to individual phonemes when uttered by the model speaker (e.g., a frequency of an amplitude peak, a resonance frequency maximum, a spectral maximum, a bounding frequency(ies), and/or a range of frequencies of a complex sound in which there is an absolute or relative maximum in the sound spectrum, etc.).

FIG. 2 illustrates ASR optimization application 206 as including an analyzing module 122 and a transformation module 124. FIG. 2 also illustrates the ASR optimization application 206 as optionally including a speech synthesizing module 126, an ASR module 208, and/or a closed captioning module 210. As discussed above with regard to FIG. 1, the analyzing module 122 may be configured to cause the computing device 102 to analyze an input audio signal 104. For example, analyzing the input audio signal 104 may comprise identifying a portion of the input audio signal 104 that corresponds to an individual phoneme uttered by the speaker 108. In some embodiments, identifying the portion of the input audio signal 104 comprises identifying a portion of the digital waveform identifying a vowel and/or vowel sound. Where the input audio signal 104 comprises a digital waveform, the analyzing module 122 may identify the portion of the input audio signal 104 that corresponds to an individual phoneme by identifying a portion of the digital waveform that includes characteristics (e.g., formant characteristics) indicative of an utterance of the individual phoneme. For example, the analyzing module 122 may determine that a portion of the digital waveform includes a pattern of formants that matches and/or is within a threshold level of similarity to the pattern of formants that are expected for a recording of an utterance of the individual phoneme. In some embodiments, when making this determination, the analyzing module 122 accesses phoneme data that describes patterns of formants and/or frequencies of formants that are expected to be present in waveform recordings of corresponding phonemes. The analyzing module 122 also may identify a first measured formant value and a second measured formant value respectively corresponding to a first and second formant component of the portion of the input audio signal 104 that corresponds to the individual phoneme. In various embodiments, the analyzing module 122 repeats this process for one or more additional formants corresponding to the individual phoneme in the input audio signal 104 (e.g., a third formant component, a fourth formant component, etc.).

The analyzing module 122 also may be configured to compare the portions of the input audio signal 104 that correspond to the individual phoneme to speech characteristics of a model speaker that previously was used to train the ASR program. For example, the analyzing module 122 may access the speech model data 212 to determine a first model formant value for a first formant component of an utterance of the individual phoneme by the model speaker as well as a second model formant value for a second formant component of the utterance of the individual phoneme by the model speaker. The analyzing module 122 then may compare the first measured formant value to the first model formant value and compare the second measured formant value to the second model formant value to determine one or more differences between the speaker 108′s utterance of the individual phoneme and the model speaker's utterance of the individual phoneme.

In some embodiments, the analyzing module 122 repeats this comparison process for each of multiple individual phonemes. For example, the analyzing module 122 may identify one or more additional portions of the input audio signal 104 that correspond to a different phoneme, and may identify additional measured formant values of the formant components present in the one or more additional portions of the input audio signal 104. The analyzing module 122 then may utilize the speech model data 212 to compare these additional measured formant values to additional model formant values that were present when a model speaker uttered the corresponding phoneme. In this way, the analyzing module 122 may determine one or more differences between the speaker 108′s utterance of the individual phoneme and the model speaker's utterance of the individual phoneme across multiple phonemes.

In some embodiments, the analyzing module 122 determines an average difference between the speech characteristics of the input audio signal 104 and the speech characteristics of the model speaker for individual formants, individual phonemes, portions of the input audio signal, the entire input audio signal, or a combination thereof. For example, the analyzing module 122 may repeat the above process for multiple portions of the input audio signal 104 that each correspond to the same phoneme, and may determine an average difference between the speech characteristics of the speaker 108 and of the model speaker when uttering the same phoneme. Such an average difference may be calculated in any appropriate manner, such as by calculating an average difference (e.g., a subtractive difference) between formant values for corresponding formant components, calculating an average proportion by which the formant values for corresponding formant components differ, calculating an average difference for a selected formant component (e.g., the first formant component, the second formant component, etc.) across a population of equivalent phonemes, calculating an average difference across all measured formant components of a given phoneme, etc.

Alternatively, or in addition, the analyzing module 122 may repeat this comparison process for each of a plurality of model speakers that were used to train the ASR program. For example, the analyzing module 122 may access the speech model data 212 to determine an additional first model formant value for a first formant component of an utterance of the individual phoneme by a different model speaker and an additional second model formant value for a second formant component of the utterance of the individual phoneme by the different model speaker. The analyzing module 122 may then compare the first measured formant value to the additional first model formant value and compare the second measured formant value to the additional second model formant value to determine one or more differences between the speaker 108′s utterance of the individual phoneme and the different model speaker's utterance of the individual phoneme. In this way, the analyzing module 122 may determine and/or select an optimal model speaker whose speech characteristics are most similar to those of the speaker 108.

The analyzing module 122 further may be executable to determine one or more differences between the first measured formant value and the first model formant value and between the second measured formant value and the second model formant value. In some embodiments, this determination includes identifying a target voice characteristic for the input audio signal 104. The target voice characteristics may correspond to and/or result from one or more changes to the input audio signal 104 that would cause the input audio signal 104 to more closely match the speech characteristics of a model speaker.

The transformation module 124 may be configured to cause the computing device 102 to perform one or more transformations on the input audio signal 104 that generate a transformed audio signal 112 that more closely matches the speech characteristics of a model speaker that previously was used to train the ASR program. In such embodiments, transforming the input audio signal may comprise modifying one or more frequency bands in the input audio signal, such as to manipulate the formant values corresponding to selected formant components. The one or more frequency bands may correspond to formant components of one or more phonemes uttered by the speaker 108. For example, the one or more frequency bands may include and/or encompass the formant values corresponding to the formant components of one or more phonemes uttered by the speaker 108. As examples, the one or more transformations may include performing a mathematical transformation (e.g., a Hilbert transform) on a portion of the input audio signal 104, on multiple portions of the input audio signal 104, or on the entire input audio signal 104 based on the one or more differences and/or the average difference determined by the analyzing module 122.

In some embodiments, the transformation module 124 applies different transformations to different portions of the input audio signal 104 (e.g., portions corresponding to different time intervals). For example, the transformation module 124 may apply a first transformation to each of one or more first portions of the input audio signal 104 that correspond to a particular phoneme, and further may apply a second transformation to each of one or more portions of the input audio signal 104 that correspond to a different phoneme. In this way, the transformation module 124 may generate a transformed audio signal 112 in which the first portions of the transformed audio signal 112 that correspond to the particular phoneme and the second portions of the transformed audio signal 112 that correspond to the different phoneme each exhibit speech characteristics (i.e., formant patterns and/or formant values) that more closely resemble the speech characteristics of a model speaker for the particular phoneme and the different phoneme, respectively.

Alternatively, or in addition, the transformation module 124 may apply a blanket transformation to all portions of the input audio signal 104. For example, where differences determined by the analyzing module 122 indicate that formant values in the input audio signal 104 are roughly and/or uniformly 80 Hz higher than the corresponding formant values corresponding to the model speaker, the transformation module 124 may apply a transformation to the input audio signal 104 to uniformly decrease the frequencies in the input audio signal 104 (e.g., by 80 Hz) so that they more closely match the speech characteristics of the model.

In some embodiments, the transformation module 124 applies the one or more transformations according to a transformation pattern. A transformation pattern may specify relational transformation values for individual phonemes and/or sets of phonemes. Such a transformation pattern may identify a first set of phonemes that each are to receive an identical transformation and a second set of phonemes that each are to receive a modified transformation. For example, a transformation pattern may specify that the transformation applied to the second set of phonemes is to be 20% of the transformation applied to the first set of phonemes (e.g., 20% of the magnitude of an additive frequency offset or of a proportional frequency offset). This may allow the ASR optimization application 206 to account for regional accents and/or dialects when transforming the input audio signal 104 to be more similar to a model speaker previously used to train the ASR program. In some embodiments, the transformation module 124 selects the transformation pattern from a set of possible and/or predetermined transformation patterns based on the one or more differences and/or the average difference determined by the analyzing module 122.

The analyzing module 122 and/or the transformation module 124 also may be configured to refine the transformed audio signal 112, the transformations applied to the input audio signal 104, and/or the selection of the optimal model speaker based on feedback from the ASR program. For example, the analyzing module 122 may repeat the above-described process on the transformed audio signal 112. This refinement may be performed by the computing device 102 in real time, and as the computing device 102 is receiving the input audio signal 104. In some embodiments, this involves identifying and comparing portions of the transformed audio signal 112 that correspond to a new phoneme that is different than the phoneme compared in the previously described process.

Alternatively, or in addition, the analyzing module 122 and/or the transformation module 124 may refine the transformed audio signal 112, the transformations applied to the input audio signal 104, and/or the selection of the optimal model speaker based on transcription data 114 received from the ASR program, where the transcription data 114 corresponds to a textual transcription of spoken language in the input audio signal 104. For example, and as discussed, the speech synthesizing module 126 may receive transcription data 114 corresponding to a textual transcription of spoken language included in the input audio signal 104 and generate a synthesized audio signal based upon the transcription data 114. The analyzing module 122 and/or the transformation module 124 may then use the synthesized audio signal to refine the transformed audio signal 112, the transformations applied to the input audio signal 104, and/or the selection of the optimal model speaker. In this way, the computing device 102 may be able to continuously update the transformations subsequently to the input audio signal 104 such that the characteristics of subsequently transformed audio signals 112 are more similar to the model used to train the ASR program, and/or to continuously update the model speaker utilized to transcribe the input audio signal 104, thus improving the accuracy of the transcription.

The ASR module 208 may be configured to transcribe the spoken language included in audio signals. In embodiments where the ASR program corresponds to an ASR module 208 stored on the memory 204 of the computing device 102, the transformed audio signal 112 may be transmitted to the ASR module 208 via an internal signal. The ASR module 208 then generates transcription data 114 that includes a textual transcription of spoken language included in the input audio signal 104. Alternatively, where the ASR program corresponds to an external ASR system 106 as depicted in FIG. 1, the input audio signal 104, the transformed audio signal 112, and/or the transcription data 114 may be transmitted between the computing device 102 and the ASR system 106 via an I/O interface 120.

As discussed, the closed captioning module 210 may be configured to generate closed captioning data that includes, or indicates, one or more captions that are to be shown in association with portions of a media signal. For example, the closed captioning module 210 may pair the text of the textual transcription of the spoken language with associated video content. For example, the transcription data 114 may include time stamps that indicate a temporal location within the input audio signal 104 for individual words and/or phonemes within the textual transcription. In such examples, the closed captioning module 210 may use the time stamps to pair portions of the textual transcription with portions of a video signal (e.g., video frames). Alternatively, or in addition, and as described herein, the closed captioning module 210 may be configured to generate a textual indication within the closed captioning data indicative of the identity of the speaker (e.g., as a member of a plurality of expected speakers) and/or of a speaker change.

In some embodiments, the closed captioning module 210 generates a captioned media signal that includes video content and closed captioning data that indicates captions that are to be presented in association with individual portions of the video content. The closed captioning module 210 may then cause the computing device 102 to distribute the closed captioning data and/or the captioned media signal to one or more customers of a closed captioning system.

According to the present disclosure, the one or more processing unit(s) 202 depicted in FIG. 2 may be configured to execute instructions, applications, or programs stored in memory 204. In some examples, the one or more processing unit(s) 202 include hardware processors that include, without limitation, a hardware central processing unit (CPU), a graphics processing unit (GPU), a field-programmable gate array (FPGA), a complex programmable logic device (CPLD), an application-specific integrated circuit (ASIC), a system-on-chip (SoC), or a combination thereof.

The memory 204 depicted in FIG. 2 is an example of computer-readable media. Computer-readable media may include two types of computer-readable media, namely, computer storage media and communication media. Computer storage media may include volatile and non-volatile, removable and non-removable media implemented in any method or technology for storage of information, such as computer-readable instructions, data structures, program modules, or other data. Computer storage media includes, but is not limited to, random access memory (RAM), read-only memory (ROM), erasable programmable read-only memory (EEPROM), flash memory or other memory technology, compact disc read-only memory (CD-ROM), digital versatile disk (DVD), or other optical storage, magnetic cassettes, magnetic tape, magnetic disk storage or other magnetic storage devices, or any other non-transmission medium that may be used to store the desired information and which may be accessed by a computing device, such as computing device 102, or other computing devices. In general, computer storage media may include computer-executable instructions that, when executed by one or more processing units, cause various functions and/or operations described herein to be performed. In contrast, communication media embody computer-readable instructions, data structures, program modules, or other data in a modulated data signal, such as a carrier wave, or other transmission mechanism. As defined herein, computer storage media does not include communication media.

Additionally, the at least one I/O interfaces 120 may include physical and/or logical interfaces for connecting the respective computing device(s) to another computing device or a network. For example, individual I/O interfaces 120 may enable WiFi-based communication such as via frequencies defined by the IEEE 802.11 standards, short range wireless frequencies such as Bluetooth®, and/or any suitable wired or wireless communications protocol that enables the respective computing device to interface with the other computing devices.

The architectures, systems, and individual elements described herein may include many other logical, programmatic, and physical components, of which those shown in the accompanying figures are merely examples that are related to the discussion herein.

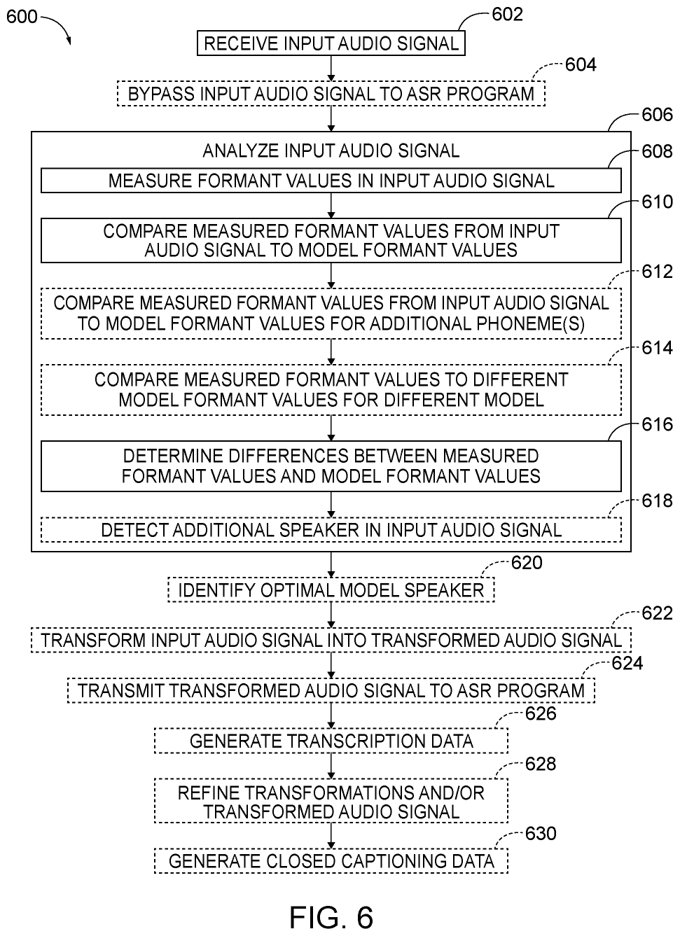

FIG. 6 schematically provides a flowchart that represents examples of methods according to the present disclosure. In FIG. 6, some steps are illustrated in dashed boxes indicating that such steps may be optional or may correspond to an optional version of a method according to the present disclosure. That said, not all methods according to the present disclosure are required to include the steps illustrated in dashed boxes. Additionally, the order of steps illustrated in FIG. 6 is exemplary, and in different embodiments the steps in FIG. 6 may be performed in a different order. Additionally, the methods and steps illustrated in FIG. 6 are not limiting, and other methods and steps are within the scope of the present disclosure, including methods having greater than or fewer than the number of steps illustrated, as understood from the discussions herein.

FIG. 6 is a flowchart depicting methods 600, according to the present disclosure, for transcribing spoken language in an input audio signal (such as the input audio signal 104) into a computer-generated text. As shown in FIG. 6, at operation 602, a computing device (such as the computing device 102) receives the input audio signal. For example, the input audio signal may be received via an I/O interface (such as the I/O interface 120) of the computing device. Example I/O interfaces for receiving the input audio signal include both (i) interfaces configured to receive data including the input audio signals (e.g., a network interface, a wired interface, an HDMI port, etc.) and (ii) interfaces configured to convert physical stimuli and/or physical recordings into data including the input audio signal (e.g., a microphone, a CD/DVD drive, an interface for receiving/transforming a physical recording of the spoken language into a digital signal, etc.).

At operation 604, the computing device optionally bypasses the input audio signal to an ASR program. For example, the computing device may transmit the input audio signal to one of an ASR module (such as the ASR module 208) executing on the computing device, an ASR system (such as the ASR system 106) at least partially separate from the computing device 102, or both. In this way, the ASR program can begin transcribing the spoken language included in the input audio signal while the computing device is initially analyzing and transforming the input audio signal, as described herein.

At operation 606, the computing device analyzes the input audio signal. Analyzing the input audio signal may comprise identifying a portion of the input audio signal that corresponds to an individual phoneme uttered by the speaker. Where the input audio signal comprises a digital waveform, the computing device may identify the portion of the input audio signal that corresponds to an individual phoneme by identifying a portion of the digital waveform that includes characteristics indicative of an utterance of the individual phoneme, such as a pattern of formants that matches and/or is within a threshold level of similarity to the pattern of formants that are expected for a recording of an utterance of the individual phoneme.

The analyzing the input audio signal at 606 may include any appropriate steps and/or operations. As shown in FIG. 6, the analyzing at 606 generally includes measuring, at 608, one or more measured formant values in the input audio signal. For example, when the analyzing the input audio signal at 606 includes identifying a portion of the input audio signal that corresponds to an individual phoneme, the measuring at 608 may include measuring one or more formant values corresponding to the individual phoneme. More specifically, the measuring at 608 may include identifying a first measured formant value corresponding to a first measured formant component of the individual phoneme and a second measured formant value corresponding to a second formant component of the individual phoneme. In some embodiments, the measuring at 608 further includes repeating this process for one or more additional formants in the input audio signal (e.g., a third formant, a fourth formant, etc.)

As further shown in FIG. 6, the analyzing at 606 generally includes comparing, at 610, measured formant values from the input audio signal to model formant values with the computing device. For example, the computing device may compare the portions of the input audio signal that correspond to the individual phoneme to speech characteristics of a model speaker that previously was used to train the ASR program, such as characteristics relating to the individual phoneme. This may correspond to the computing device accessing a first model formant value for a first formant component of an utterance of the individual phoneme by the model speaker and a second model formant value for a second formant component of the utterance of the individual phoneme by the model speaker. In this way, the comparing at 610 generally includes comparing the first measured formant value to the first model formant value and comparing the second measured formant value to the second model formant value, and additionally may include performing analogous comparisons for third model formant values, fourth model formant values, etc.

As further shown in FIG. 6, the analyzing at 606 additionally may include comparing, at 612, one or more measured formant values from the input audio signal to the model formant values for additional individual phonemes. For example, the comparing at 612 may include identifying, with the computing device, one or more additional portions of the input audio signal that correspond to a different phoneme (e.g., different than the individual phoneme considered during the comparing at 610), and may identify additional measured formant values corresponding to the formant components present in the one or more additional portions of the input audio signal. In this way, the comparing at 612 generally includes comparing the first (i.e., lowest-frequency) measured formant value to the first (i.e., lowest-frequency) model formant value and comparing the second (i.e., second-lowest-frequency) measured formant value to the second (i.e., second-lowest-frequency) model formant value for a different phoneme than was considered during the comparing at 610. The comparing at 612 additionally may include performing analogous comparisons for third model formant values, fourth model formant values, etc. for the different phoneme. Accordingly, in this manner, the analyzing the input audio signal at 606 may include performing a comparison of the measured formant values and the model formant values for each of a plurality of distinct phonemes.

As further shown in FIG. 6, the analyzing at 606 additionally may include comparing, at 614, the measured formant values from the input audio signal to different model formant values for each of one or more different model speakers. For example, the comparing at 614 may include determining, with the computing device, an additional first model formant value for a first formant component of an utterance of the individual phoneme by a different model speaker (e.g., different than the model speaker utilized in the comparing at 610 and/or the comparing at 612) and a second additional model formant value for a second formant component of the utterance of the individual phoneme by the different model speaker. In this way, the comparing at 614 generally includes comparing the first measured formant value to the additional first model formant value and comparing the second measured formant value to the second additional model formant value, and additionally may include performing analogous comparisons for third model formant values, fourth model formant values, etc.

As further shown in FIG. 6, the analyzing at 606 generally includes determining, at 616, one or more differences between the speaker's utterance of an individual phoneme (as encoded in the input audio signal) and a model speaker's utterance of the individual phoneme. The determining the one or more differences at 616 may be based upon any suitable comparison of the speaker's utterance and the model speaker's utterance, such as may be responsive to and/or based on the comparing at 610, the comparing at 612, and/or the comparing at 614. For example, the computing device may determine one or more differences between the first measured formant value and the first model formant value and between the second measured formant value and the second model formant value, and/or between any other pair of corresponding formant values (such as may correspond to the third formant component, the fourth formant component, etc.), for each of any appropriate number of phonemes and/or model speakers. The determining the one or more differences at 616 may include comparing the formant values in any appropriate manner. As examples, determining a difference between a pair of formant values may include calculating an arithmetic difference between the formant values (e.g. via a subtraction operation), calculating a ratio and/or a percentage difference between the formant values (e.g. via a division operation), and/or any other appropriate mathematical and/or quantitative comparison of the formant values.

In some embodiments, the computing device determines an average difference between the speech characteristics of the input audio signal and the speech characteristics of the model speaker for individual formants, individual phonemes, portions of the input audio signal, the entire input audio signal, or a combination thereof. For example, the computing device may repeat one or more of the processes described in operations 610, 612, and/or 614 for different portions of the input audio signal, and may determine an average difference between the speech characteristics of the speaker when uttering the same phoneme(s) and the speech characteristics of the model speaker when uttering the same phoneme(s).

As further shown in FIG. 6, the analyzing at 606 additionally may include detecting, at 618, an additional speaker in the input audio signal. This may include the computing device detecting a change in the speech characteristics in the input audio signal. For example, the computing device may detect a portion of the input audio signal that has speech characteristics (e.g., measured formant values corresponding to specific formant components of specific phonemes) that are different from the speech characteristics in previously analyzed portions of the input audio signal. In some embodiments, when such a change in speech characteristics is detected, the process returns to initiating the analyzing at 606 by analyzing the portion of the input audio signal that includes the different speech characteristics (such as via the comparing at 610, the comparing at 612, the comparing at 614, and/or the determining at 616). In this way, techniques described herein enable the computing device to perform separate analyses, transformations, and/or processing optimizations on the portions of the input audio signal that are associated with different speakers, as described herein.

As a result of the analyzing the input audio signal at 606, methods 600 may include optimizing the fidelity of a transcription of the input audio signal in any appropriate manner. For example, and as shown in FIG. 6, methods 600 additionally may include identifying, at 620, an optimal model speaker to be utilized by an ASR program when processing the input audio signal. As a more specific example in which the analyzing the input audio signal at 606 includes the comparing at 610 and the comparing at 614 (i.e., thereby comparing the speech characteristics of the input audio signal to each of a plurality of model speakers), the determining the one or more differences at 616 may result in an identification of a model speaker of the plurality of model speakers that minimizes one or more of the differences determined at operation 616. Stated differently, in such examples, the determining at 616 may include repeating the determining the one or more differences for each of two or more model speakers (such as two model speakers, three model speakers, four model speakers, or more than four model speakers) such that the optimal model speaker may be identified among the plurality of model speakers. Accordingly, in such examples, the identifying at 620 may include identifying the optimal model speaker whose speech characteristics most closely match those measured in the input audio signal.

Additionally or alternatively, and as further shown in FIG. 6, methods 600 may include optimizing the fidelity of the transcription of the input audio signal by transforming, at 622, the input audio signal into a transformed audio signal (such as transformed audio signal 112). In some embodiments, the transformations applied during the transforming at 622 are based on the one or more differences and/or the average difference determined by the computing device in the determining at 616. For example, the computing device may perform one or more transformations on the input audio signal that result in the generation of a transformed audio signal that more closely matches the speech characteristics of a model that previously was used to train the ASR program. In some embodiments, transforming the input audio signal comprises modifying one or more frequency bands in the input audio signal. The one or more frequency bands may correspond to formant components of one or more phonemes uttered by the speaker. For example, the transforming at 622 may include performing a mathematical transformation (e.g., a Hilbert transform) on a portion of the input audio signal, on multiple portions of the input audio signal, or on the entire input audio signal. The one or more transformations may include blanket transformations applied to the entire input audio signal, targeted transformations applied to portions of the input audio signal, and/or both, as described herein.

In some embodiments, the one or more transformations performed in the transforming at 622 are applied by the computing device according to a transformation pattern. A transformation pattern may specify relational transformation values for individual phonemes and/or sets of phonemes. Such a transformation pattern may identify a first set of phonemes that each are to receive an identical transformation and a second set of phonemes that each are to receive a modified transformation. For example, a transformation pattern may specify that the transformation applied to the second set of phonemes is to be 20% of the transformation applied to the first set of phonemes (e.g., 20% of the magnitude of an additive frequency offset or of a proportional frequency offset). This may allow the computing device to account for regional accents and/or dialects when transforming the input audio signal to be more similar to a model speaker previously used to train the ASR program. In some embodiments, the computing device selects the transformation pattern from a set of possible transformation patterns based on the one or more differences and/or the average difference determined in the determining at 616.

As further shown in FIG. 6, methods 600 additionally may include transmitting, at 624, the transformed audio signal to the ASR program with the computing device. Where the ASR program comprises an ASR module executing on the computing device, the transformed signal may be transmitted via internal computing signals of the computing device. Where the ASR program comprises an ASR system partially or entirely separate from the computing device, the transformed signal may be transmitted via the I/O interface of the computing device (e.g., a network interface).

As further shown in FIG. 6, methods 600 additionally may include generating, at 626, transcription data with the ASR program. For example, where the ASR program comprises an ASR module executing on the computing device, the computing device may determine and transcribe the spoken language included in the input audio signal and/or the transformed audio signal. As a more specific example, in an example in which methods 600 include the identifying the optimal model speaker at 620, the generating the transcription data at 626 generally includes the ASR program processing the input audio signal in accordance with the speech characteristics of the optimal model speaker. Because the optimal model speaker has been chosen such that the speech characteristics of the optimal model speaker are most similar to those measured in the input audio signal, the accuracy of the transcription of the input audio signal is greater than if the ASR program processed the input audio signal in accordance with the speech characteristics of a random and/or arbitrary model speaker.

As another example in which methods 600 include the transforming the input audio signal into the transformed audio signal, the generating the transcription data at 626 generally includes the ASR program processing the transformed audio signal in accordance with the speech characteristics of the model speaker that the transformed audio signal has been configured to emulate. Thus, because the transformed audio signal has been modified to be more similar to the speech characteristics of a model speaker used to train the ASR program, the accuracy of the transcription of the transformed audio signal is greater than a transcription of the input audio signal. This is true regardless of the identity of the speaker who uttered the spoken language in the input audio signal.

As further shown in FIG. 6, methods 600 additionally may include refining, at 628, the transformations and/or transformed audio signal with the computing device. For example, the computing device may be configured to refine the transformed audio signal and/or the transformations applied to the input audio signal based on feedback from the ASR program, as described herein. In some embodiments, the refining the transformed audio signal at 628 includes repeating one or more of the analyzing at 606 (and/or any appropriate substeps thereof), the identifying at 620, the transforming at 622, the transmitting at 624, and the generating at 626 for the transformed audio signal. This refinement may be performed by the computing device in real time, such as while the computing device is receiving the input audio signal. In this way, the computing device may be configured to continuously update the transformations applied to the input audio signal by the transforming at 622 such that subsequent transformed audio signals have an improved similarity to the model used to train the ASR program, thus improving the accuracy of the transcription.

Alternatively, or in addition, the refining the transformed audio signal and/or the transformations applied to the input audio signal at 628 may be at least partially based on transcription data received from the ASR program. For example, the computing device may receive or generate a synthesized audio signal based on the transcription data, such as via a speech synthesizing module (such as speech synthesizing module 126). The synthesized audio signal may correspond to a computer-generated audio signal that includes the spoken language in the transcription data. The computing device may then use the synthesized audio signal to refine the transformed audio signal and/or the transformations applied to the input audio signal, as described herein.

In some embodiments, the transcribed data is used to train the ASR program to recognize the speaker who uttered the spoken language in the input audio signal. For example, by comparing the transcribed spoken language with the speech characteristics of the input audio signal, the computing device may train the ASR program to learn the speech characteristics of the speaker. That is, the computing device may train the ASR program to recognize and/or know the speech characteristics of the speaker by comparing individual speech characteristics exhibited in the input audio signal with corresponding portions of the textual transcription of the spoken language included in the transformed audio signal. For example, once the ASR program learns individual speech characteristics of the speaker, the ASR program may utilize those individual speech characteristics later in time when transcribing other portions of the transformed audio signal and/or other transcribed input signals associated with the speaker. In this way, the methods disclosed herein may be utilized to train the ASR program to learn (e.g., to expand its collection of stored speech models and/or model speakers) while also providing accurate transcriptions of the utterances of a previously unknown speaker.

With continued reference to FIG. 6, methods 600 additionally may include generating, at 630, closed captioning data. The generating the closed captioning data at 630 may be performed with the computing device and/or with a closed captioning system (such as the closed captioning system 116). For example, the computing device may be configured to generate closed captioning data that includes, or indicates, one or more captions that are to be shown in association with portions of a media signal. In some embodiments, this includes the computing device pairing the text of the textual transcription of the spoken language with associated video content (e.g., video frames within a video signal). The computing device may then transmit the closed captioning data to be presented in association with individual portions of the video content. In some embodiments, the computing device further generates a captioned media signal that includes both the generated closed captions and the associated video content. In such embodiments, the computing device may transmit the captioned media signal to one or more customers of a closed captioning system.

In examples of methods 600 in which the analyzing the input audio signal at 606 includes the detecting the additional speaker in the input audio signal at 618, the generating the closed captioning data at 630 additionally may include generating a textual indication within the closed captioning data indicative of the speaker change. Alternatively, or in addition, and as described herein, the closed captioning system may be configured such that the generating at 630 includes generating a textual indication of the identity of the speaker that is producing the input audio signal, such as in conjunction with generating the textual indication indicative of the speaker change. Such functionality may be especially desirable when the captions are to be received by users who are deaf or hard of hearing, who otherwise may struggle to identify a speaker and/or a speaker change from closed captions based upon context alone.

Since the techniques disclosed herein do not require the ASR system to have previously been trained to understand the speaker associated with the input audio signal, they enable the computing device to generate closed captions for previously unknown speakers. This can be especially helpful in situations where closed captions for an unexpected live broadcast must be generated. Rather than seeking immediate assistance from human transcribers, the techniques disclosed herein may be used to immediately generate accurate closed captioning data for the live broadcast. Moreover, where the computing device is configured to train the ASR program using the transcription data, the accuracy of the closed captioning data may improve over the course of the live broadcast, as the techniques described herein allow the ASR program to bootstrap an understanding of the speech characteristics of previously unknown speakers (i.e., speakers for which the ASR program was not previously trained and/or does not have data indicating the specific speech characteristics), as described herein.

Methods 600 are described with reference to the environment 100 and system 200 of FIGS. 1-2 for convenience and ease of understanding. However, methods 600 are not limited to being performed using the environment 100 and/or system 200. Moreover, the environment 100 and system 200 are not limited to performing the methods 600.

Methods 600 are illustrated as collections of blocks in logical flow graphs, which represent sequences of operations that may be implemented in hardware, software, or a combination thereof. In the context of software, the blocks represent computer-executable instructions stored on one or more computer-readable storage media that, when executed by one or more processing units, perform the recited operations. Generally, computer executable instructions include routines, programs, objects, components, data structures, and the like that perform particular functions or implement particular abstract data types. The order in which the operations are described is not intended to be construed as a limitation, and any number of the described blocks may be combined in any order and/or in parallel to implement the methods. In some embodiments, one or more blocks of the method are omitted entirely. The various techniques described herein may be implemented in the context of computer-executable instructions or software, that are stored in computer-readable storage and executed by the processor(s) of one or more computers or other devices such as those illustrated in the figures. Other architectures may be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

Examples of inventive subject matter according to the present disclosure are described in the following enumerated paragraphs.

A1. A computer-implemented method for improving the accuracy of voice to text conversion, the method comprising:

receiving an input audio signal that includes spoken language uttered by a speaker; and

analyzing the input audio signal;

wherein the analyzing the input audio signal includes:

comparing, with a computing device, one or more measured formant values to one or more model formant values, wherein each of the one or more measured formant values corresponds to a respective measured formant component of one or more measured formant components of an individual phoneme in the input audio signal, and wherein each of the one or more model formant values corresponds to a respective model formant component of one or more model formant components of the individual phoneme in a trained model of an automatic speech recognition (ASR) application; and

determining, with the computing device, one or more differences between the one or more measured formant values and the one or more model formant values.

A2. The computer-implemented method of paragraph A1, wherein the trained model corresponds to a standard waveform for which the ASR application has been trained.

A3. The computer-implemented method of any of paragraphs A1-A2, wherein the input audio signal is an electrical signal generated by a microphone.

A4. The computer-implemented method of any of paragraphs A1-A3, wherein the input audio signal is an audio component of a media signal.

A5. The computer-implemented method of paragraph A4, wherein the media signal also includes a video signal.

A6. The computer-implemented method of any of paragraphs A4-A5, wherein the receiving the input audio signal includes extracting the input audio signal from the media signal.

A7. The computer-implemented method of any of paragraphs A1-A6, wherein the input audio signal comprises a waveform pattern.

A8. The computer-implemented method of paragraph A7, wherein the waveform pattern corresponds to speech from a speaker detected by a/the microphone.

A9. The computer-implemented method of any of paragraphs A7-A8, wherein the waveform pattern corresponds to frequencies of detected audio over time.

A10. The computer-implemented method of any of paragraphs A7-A9, wherein the waveform pattern is a spectrograph, spectral waterfall, spectral plot, voiceprint, and/or voicegram.

A11. The computer-implemented method of any of paragraphs A1-A10, wherein each of the one or more measured formant components corresponds to a frequency component of the input audio signal.

A12. The computer-implemented method of any of paragraphs A1-A11, wherein each of the one or more measured formant components corresponds to a frequency component of an acoustic signal produced by speech.

A13. The computer-implemented method of any of paragraphs A1-A12, wherein the individual phoneme corresponds to a vowel.

A14. The computer-implemented method of any of paragraphs A1-A13, wherein the comparing the one or more measured formant values to the one or more model formant values includes accessing speech model data that includes, or indicates, one or more model formant values for each of a/the plurality of phonemes.

A15. The computer-implemented method of paragraph A14, wherein the speech model data comprises the trained model corresponding to each of one or more speakers used to train the ASR application.

A16. The computer-implemented method of paragraph A15, wherein each trained model includes one or more model formant values corresponding to each of the plurality of phonemes as spoken by the corresponding speaker used to train the ASR application.

A17. The computer-implemented method of any of paragraphs A1-A16, wherein the analyzing the input audio signal includes identifying one or more portions of the input audio signal that correspond to the individual phoneme.

A18. The computer-implemented method of any of paragraphs A1-A17, wherein the one or more measured formant values correspond to the N lowest-frequency measured formant components of the individual phoneme of the input audio signal; wherein the one or more model formant values correspond to the N lowest-frequency model formant components of the individual phoneme in the trained model; and wherein N is an integer that is at least 1 and at most 6.

A19. The computer-implemented method of any of paragraphs A1-A18, wherein the one or more measured formant values include at least a first measured formant value corresponding to a first measured formant component of the individual phoneme in the input audio signal; wherein the one or more model formant values include at least a first model formant value corresponding to a first model formant component of the individual phoneme in the trained model; and wherein the determining the one or more differences includes determining one or more differences between the first measured formant value and the first model formant value.

A20. The computer-implemented method of paragraph A19, wherein the one or more measured formant values further includes an Mth measured formant value corresponding to an Mth measured formant component of the individual phoneme in the input audio signal; wherein the one or more model formant values further includes an Mth model formant value corresponding to an Mth model formant component of the individual phoneme in the trained model; wherein the determining the one or more differences further includes determining one or more differences between the Mth measured formant value and the Mth model formant value; and wherein M is an integer that is at least 2 and at most 6.

A21. The computer-implemented method of any of paragraphs A19-A20, wherein the determining the one or more differences includes one or more of:

determining a difference between the first measured formant value and the first model formant value; and

determining a difference between a/the Mth measured formant value and a/the Mth model formant value.

A22. The computer-implemented method of any of paragraphs A1-A21, wherein the one or more measured formant values includes two or more measured formant values, wherein the one or more model formant values includes two or more model formant values, and wherein the determining the one or more differences includes one or both of:

determining one or more differences among the two or more measured formant values; and determining one or more differences among the two or more model formant values.

A23. The computer-implemented method of any of paragraphs A1-A22, wherein the analyzing the input audio signal further includes, prior to the comparing the one or more measured formant values to the one or more model formant values, measuring, with the computing device, the one or more measured formant values from the input audio signal.

A24. The computer-implemented method of paragraph A23, wherein the measuring the one or more measured formant values includes:

identifying the one or more measured formant components corresponding to the individual phoneme; and

measuring the one or more measured formant values corresponding to each of the one or more measured formant components corresponding to the individual phoneme.

A25. The computer-implemented method of any of paragraphs A23-A24, wherein the measuring the one or more measured formant values includes measuring a/the first measured formant value corresponding to a/the first measured formant component, wherein the first measured formant component is the lowest-frequency formant component of the individual phoneme.

A26. The computer-implemented method of any of paragraphs A23-A25, wherein the measuring the one or more measured formant values includes measuring a/the Mth measured formant value corresponding to a/the Mth measured formant component, wherein the Mth measured formant component is the Mth-lowest-frequency component of the individual phoneme, and wherein M is an/the integer that is at least 2 and at most 6.

A27. The computer-implemented method of any of paragraphs A1-A26, wherein the analyzing the input audio signal includes identifying a plurality of portions of the input audio signal corresponding to a plurality of distinct individual phonemes in the input audio signal, and wherein the measuring the one or more measured formant values includes measuring a respective set of one or more measured formant values corresponding to a respective set of one or more measured formant components for each individual phoneme in the plurality of distinct individual phonemes.

A28. The computer-implemented method of any of paragraphs A1-A27, wherein the analyzing the input audio signal includes identifying a/the plurality of portions of the input audio signal corresponding to a plurality of distinct individual phonemes in the input audio signal, and wherein the analyzing the input audio signal includes repeating the comparing the one or more measured formant values to the one or more model formant values and the determining the one or more differences between the one or more measured formant values and the one or more model formant values for each individual phoneme of the plurality of distinct individual phonemes.

A29. The computer-implemented method of any of paragraphs A1-A28, wherein the ASR application includes a plurality of trained models, and wherein the analyzing the input audio signal includes repeating the comparing the one or more measured formant values to the one or more model formant values for each trained model of the plurality of trained models.

A30. The computer-implemented method of any of paragraphs A1-A29, wherein the ASR application includes a plurality of trained models, and wherein the method further includes identifying an optimal trained model of the plurality of trained models for processing the input audio signal with the ASR application.

A31. The computer-implemented method of paragraph A30, wherein the identifying the optimal trained model includes identifying the trained model that represents speech characteristics that are most similar to speech characteristics of the input audio signal.

A32. The computer-implemented method of any of paragraphs A30-A31, wherein the analyzing the input audio signal includes repeating the determining the one or more differences between the one or more measured formant values and the one or more model formant values for each trained model of the plurality of trained models, and wherein the identifying the optimal trained model includes identifying which trained model of the plurality of trained models minimizes the one or more differences between the one or more measured formant values and the one or more model formant values.

A33. The computer-implemented method of any of paragraphs A1-A32, the method further comprising:

transforming the input audio signal into a transformed audio signal that more closely matches the trained model, wherein the transforming includes applying one or more transformations to the input audio signal, wherein the one or more transformations are based, at least in part, on the determining the one or more differences; and

transmitting the transformed audio signal to the ASR application.

A34. The computer-implemented method of paragraph A33, further comprising: storing target voice characteristics; wherein the storing is based, at least in part, on the determining the one or more differences; and wherein the transforming the input audio signal is further based on the target voice characteristics.

A35. The computer-implemented method of any of paragraphs A33-A34, when dependent from paragraph A27, wherein the transforming further is based, at least in part, on the determining the one or more differences for each individual phoneme of the plurality of distinct individual phonemes.

A36. The computer-implemented method of any of paragraphs A33-A35, wherein the transforming the input audio signal comprises applying a blanket transformation to the input audio signal.

A37. The computer-implemented method of paragraph A36, wherein the blanket transformation modifies the frequencies of the input audio signal to better match the frequencies of the trained model.

A38. The computer-implemented method of any of paragraphs A33-A37, wherein transforming the input audio signal comprises modifying the input audio signal with a Hilbert transform.

A39. The computer-implemented method of any of paragraphs A33-A38, wherein the transforming the input audio signal comprises modifying one or more frequency bands in the input audio signal.

A40. The computer-implemented method of paragraph A39, wherein each of the one or more frequency bands corresponds to a respective formant component of a phoneme.

A41. The computer-implemented method of any of paragraphs A39-A40, wherein the one or more frequency bands correspond to a respective formant component of a single phoneme, optionally the individual phoneme.

A42. The computer-implemented method of paragraph A41, wherein the transforming the input audio signal comprises modifying one or more additional frequency bands in the input audio signal that correspond to respective formant components of an additional single phoneme that is different than the individual phoneme.

A43. The computer-implemented method of paragraph A42, wherein the transforming the input audio signal comprises applying a same transformation to the one or more frequency bands in the input audio signal that correspond to the single phoneme and to the one or more additional frequency bands in the input audio signal that correspond to the additional single phoneme.

A44. The computer-implemented method of paragraph A42, wherein the transforming the input audio signal comprises:

applying a first transformation to the one or more frequency bands in the input audio signal that correspond to the single phoneme; and

applying a second transformation to the one or more additional frequency bands in the input audio signal that correspond to the additional single phoneme;

wherein the second transformation is different than the first transformation.

A45. The computer-implemented method of any of paragraphs A33-A44, wherein the transforming the input audio signal is based, at least in part, on a transformation pattern.

A46. The computer-implemented method of paragraph A45, wherein the transformation pattern specifies relational transformation values for each of a plurality of individual phonemes and/or sets of phonemes.

A47. The computer-implemented method of any of paragraphs A45-A46, wherein the transforming comprises selecting the transformation pattern from a set of transformation patterns based, at least in part, on the determining the one or more differences.

A48. The computer-implemented method of any of paragraphs A45-A47, wherein the transformation pattern specifies at least a first transformation to be applied to a first portion of the input audio signal and a second transformation to be applied to a second portion of the input audio signal.

A49. The computer-implemented method of paragraph A48, wherein the first portion of the input audio signal corresponds to at least one phoneme in the input audio signal, wherein the second portion of the input audio signal corresponds to at least an additional phoneme in the input audio signal, and wherein the at least one phoneme is different from the at least an additional phoneme.

A50. The computer-implemented method of any of paragraphs A48-A49, wherein the transforming comprises modifying at least the first portion of the input audio signal.

A51. The computer-implemented method of any of paragraphs A1-A50, further comprising: generating transcription data with the ASR application, wherein the transcription data is based, at least in part, on the input audio signal.

A52. The computer-implemented method of paragraph A51, wherein the generating the transcription data includes determining and transcribing spoken language included in the input audio signal into a textual transcription of the spoken language.

A53. The computer-implemented method of any of paragraphs A51-A52, wherein the generating the transcription data includes processing, with the ASR application, the input audio signal in accordance with the speech characteristics of the trained model, optionally a/the optimal trained model.

A54. The computer-implemented method of any of paragraphs A51-A53, wherein the generating the transcription data includes processing, with the ASR application, the transformed audio signal in accordance with the speech characteristics of the trained model, optionally a/the optimal trained model.

A55. The computer-implemented method of any of paragraphs A1-A54, further comprising, subsequent to the transforming the input audio signal, refining, with the computing device, one or both of the transformations and the transformed audio signal.

A56. The computer-implemented method of paragraph A55, wherein the refining includes: measuring one or more transformed formant values corresponding to one or more transformed formant components in the transformed audio signal;

comparing, with the computing device, the one or more transformed formant values to an additional one or more model formant values corresponding to an additional one or more model formant components of an additional phoneme in the trained model;

determining, with the computing device, one or more transformed differences between the one or more transformed formant values and the additional one or more model formant values; and

modulating the transformed audio signal to form a refined transformed audio signal that more closely matches speech characteristics of the trained model than does the transformed audio signal;

wherein the modulating the transformed audio signal includes applying a refined transformation to the transformed audio signal; wherein the refined transformation is based, at least in part, on the one or more transformed differences.

A57. The computer-implemented method of any of paragraphs A1-A56, wherein the additional phoneme is the same as the individual phoneme.

A58. The computer-implemented method of paragraph A56, wherein the additional phoneme is a different phoneme than the individual phoneme.

A59. The computer-implemented method of any of paragraphs A55-A58, further comprising: periodically repeating the refining one or both of the transformations and the transformed audio signal.

A60. The computer-implemented method of any of paragraphs A55-A59, when dependent from paragraph A51, wherein the refining further includes receiving, from the ASR application, the transcription data.

A61. The computer-implemented method of paragraph A60, wherein the refining further includes generating, with the computing device, a synthesized audio signal that corresponds to the transcription data, and wherein the refining is based, at least in part, on the synthesized audio signal.

A62. The computer-implemented method of paragraph A61, wherein the refining the transformed audio signal comprises comparing the synthesized audio signal to the transformed audio signal, and wherein a/the modulating the transformed audio signal is based, at least in part, on the comparing the synthesized audio signal to the transformed audio signal.

A63. The computer-implemented method of any of paragraphs A1-A62, further comprising:

bypassing the input audio signal to the ASR program.

A64. The computer-implemented method of paragraph A63, wherein the bypassing includes transmitting, with the computing device, the input audio signal to the ASR program.

A65. The computer-implemented method of any of paragraphs A63-A64, wherein the bypassing is performed at least partially concurrent with the analyzing the input audio signal.

A66. The computer-implemented method of any of paragraphs A63-A64, when dependent from paragraph A51, wherein the generating the transcription data includes generating and transcribing a/the spoken language included in the input audio signal that is bypassed to the ASR program in the bypassing.

A67. The computer-implemented method of paragraph A66, wherein the generating the transcription data is performed at least partially concurrent with the analyzing the input audio signal.

A68. The computer-implemented method of any of paragraphs A63-A67, further comprising, responsive to the transforming the input audio signal into the transformed audio signal:

ceasing the bypassing the input audio signal to the ASR program; and

initiating the transmitting the transformed audio signal to the ASR program.

A69. The computer-implemented method of any of paragraphs A1-A68, wherein the analyzing the input audio signal further comprises: detecting an additional speaker in the input audio signal.

A70. The computer-implemented method of paragraph A69, wherein the detecting the additional speaker includes detecting a change in the speech characteristics of the input audio signal.

A71. The computer-implemented method of any of paragraphs A69-A70, wherein the measuring the formant values in the input audio signal includes measuring an outlier formant value corresponding to a particular formant component of a particular phoneme that differs from the measured formant value corresponding to the particular formant component of the particular phoneme, and wherein the detecting the additional speaker corresponds to identifying the outlier formant value.

A72. The computer-implemented method of any of paragraphs A69-A71, wherein the detecting the additional speaker includes detecting an identity of the additional speaker.

A73. The computer-implemented method of any of paragraphs A69-A72, further comprising: repeating one or more of the analyzing the input audio signal , a/the identifying the optimal trained model, and a/the transforming the input audio signal for at least a portion of the input audio signal that is generated by the additional speaker.

A74. The computer-implemented method of any of paragraphs A1-A73, when dependent from paragraph A51, further comprising: generating, with the computing device, closed captioning data that are to be shown in association with portions of a/the media signal, wherein the generating the closed captioning data is based, at least in part, on the generating the transcription data, and wherein the closed captioning data include a/the textual transcription of a/the spoken language included in the input audio signal.

A75. The computer-implemented method of paragraph A74, wherein the closed captioning data include a textual indication that the speaker has changed from the speaker to the additional speaker.

A76. The computer-implemented method of any of paragraphs A74-A75, wherein the detecting the additional speaker includes detecting the identity of the additional speaker, and wherein the closed captioning data include a textual identification of the identity of the additional speaker.

B1. A computing device, comprising: a processor; and a memory that stores non-transitory computer readable instructions that, when executed by the processor, cause the computing device to perform the method of any of paragraphs A1-A76.

B2. The computing device of paragraph B1, further comprising a/the microphone electrically connected to the computing device and configured to transmit an input audio signal to the processor.

C1. A non-transitory computer readable medium storing instructions that, when executed by a processor, cause a computing device to perform the computer-implemented method of any of paragraphs A1-A76.

D1. The use of the computing device of any of paragraphs B1-B2 to perform the computer-implemented method of any of paragraphs A1-A76.

E1. The use of the non-transitory computer readable medium of paragraph C1 to perform the computer-implemented method of any of paragraphs A1-A76.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” may mean A alone, B alone, C alone, A and B together, A and C together, B and C together, A, B, and C together, and optionally any of the above in combination with at least one other entity.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

The various disclosed elements of systems and steps of methods disclosed herein are not required of all systems and methods according to the present disclosure, and the present disclosure includes all novel and non-obvious combinations and subcombinations of the various elements and steps disclosed herein. Moreover, any of the various elements and steps, or any combination of the various elements and/or steps, disclosed herein may define independent inventive subject matter that is separate and apart from the whole of a disclosed system or method. Accordingly, such inventive subject matter is not required to be associated with the specific systems and methods that are expressly disclosed herein, and such inventive subject matter may find utility in systems and/or methods that are not expressly disclosed herein.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, also are regarded as included within the subject matter of the inventions of the present disclosure.

1. A computer-implemented method for improving the accuracy of voice to text conversion, the method comprising:
receiving an input audio signal that includes spoken language uttered by a speaker; and
analyzing the input audio signal;
wherein the analyzing the input audio signal includes:
comparing, with a computing device, one or more measured formant values to one or more model formant values, wherein each of the one or more measured formant values corresponds to a respective measured formant component of one or more measured formant components of an individual phoneme in the input audio signal, and wherein each of the one or more model formant values corresponds to a respective model formant component of one or more model formant components of the individual phoneme in a trained model of an automatic speech recognition (ASR) application; and
determining, with the computing device, one or more differences between the one or more measured formant values and the one or more model formant values.

2. The computer-implemented method of claim 1, wherein the one or more measured formant values correspond to the N lowest-frequency measured formant components of the individual phoneme of the input audio signal; wherein the one or more model formant values correspond to the N lowest-frequency model formant components of the individual phoneme in the trained model; and wherein N is an integer that is at least 2 and at most 4.

3. The computer-implemented method of claim 1, wherein the one or more measured formant values further includes an Mth measured formant value corresponding to an Mth measured formant component of the individual phoneme in the input audio signal; wherein the one or more model formant values further includes an Mth model formant value corresponding to an Mth model formant component of the individual phoneme in the trained model; wherein the determining the one or more differences further includes determining one or more differences between the Mth measured formant value and the Mth model formant value; and wherein M is an integer that is at least 2 and at most 6.

4. The computer-implemented method of claim 1, wherein the ASR application includes a plurality of trained models, and wherein the method further includes identifying an optimal trained model of the plurality of trained models for processing the input audio signal with the ASR application, wherein the identifying the optimal trained model includes identifying the trained model that represents speech characteristics that are most similar to speech characteristics of the input audio signal.

5. The computer-implemented method of claim 4, wherein the analyzing the input audio signal includes repeating the determining the one or more differences between the one or more measured formant values and the one or more model formant values for each trained model of the plurality of trained models, and wherein the identifying the optimal trained model includes identifying which trained model of the plurality of trained models minimizes the one or more differences between the one or more measured formant values and the one or more model formant values.

6. The computer-implemented method of claim 4, further comprising generating transcription data with the ASR application, wherein the transcription data is based, at least in part, on the input audio signal, and wherein the generating the transcription data includes processing, with the ASR application, the input audio signal in accordance with the speech characteristics of the optimal trained model.

7. The computer-implemented method of claim 1, the method further comprising:
transforming the input audio signal into a transformed audio signal that more closely matches the trained model, wherein the transforming includes applying one or more transformations to the input audio signal, wherein the one or more transformations are based, at least in part, on the determining the one or more differences; and
transmitting the transformed audio signal to the ASR application.

8. The computer-implemented method of claim 7, further comprising generating transcription data with the ASR application, wherein the transcription data is based, at least in part, on the input audio signal, and wherein the generating the transcription data includes processing, with the ASR application, the transformed audio signal in accordance with the speech characteristics of the trained model.

9. The computer-implemented method of claim 7, wherein the transforming the input audio signal comprises modifying one or more frequency bands in the input audio signal, wherein each of the one or more frequency bands corresponds to a respective formant component of the individual phoneme.

10. The computer-implemented method of claim 9, wherein the transforming the input audio signal comprises modifying one or more additional frequency bands in the input audio signal that correspond to respective formant components of an additional single phoneme that is different than the individual phoneme.

11. The computer-implemented method of claim 7, wherein the transforming the input audio signal is based, at least in part, on a transformation pattern that specifies relational transformation values for each of a plurality of individual phonemes.

12. The computer-implemented method of claim 11, wherein the transformation pattern specifies at least a first transformation to be applied to a first portion of the input audio signal and a second transformation to be applied to a second portion of the input audio signal, wherein the first portion of the input audio signal corresponds to at least one phoneme in the input audio signal, wherein the second portion of the input audio signal corresponds to at least an additional phoneme in the input audio signal, and wherein the at least one phoneme is different from the at least an additional phoneme.

13. The computer-implemented method of claim 7, further comprising, subsequent to the transforming the input audio signal, refining, with the computing device, one or both of the transformations and the transformed audio signal.

14. The computer-implemented method of claim 13, wherein the refining includes:
measuring one or more transformed formant values corresponding to one or more transformed formant components in the transformed audio signal;
comparing, with the computing device, the one or more transformed formant values to an additional one or more model formant values corresponding to an additional one or more model formant components of an additional phoneme in the trained model;
determining, with the computing device, one or more transformed differences between the one or more transformed formant values and the additional one or more model formant values; and
modulating the transformed audio signal to form a refined transformed audio signal that more closely matches speech characteristics of the trained model than does the transformed audio signal;
wherein the modulating the transformed audio signal includes applying a refined transformation to the transformed audio signal; wherein the refined transformation is based, at least in part, on the one or more transformed differences.

15. The computer-implemented method of claim 13, further comprising generating transcription data with the ASR application, wherein the transcription data is based, at least in part, on the input audio signal; wherein the refining further includes:
receiving, from the ASR application, the transcription data;
generating, with the computing device, a synthesized audio signal that corresponds to the transcription data;
comparing the synthesized audio signal to the transformed audio signal; and
modulating the transformed audio signal based, at least in part, on the comparing the synthesized audio signal to the transformed audio signal.

16. The computer-implemented method of claim 1, further comprising:
generating transcription data with the ASR application, wherein the transcription data is based, at least in part, on the input audio signal, and wherein the generating the transcription data includes determining and transcribing spoken language included in the input audio signal into a textual transcription of the spoken language; and
generating, with the computing device, closed captioning data that are to be shown in association with portions of a media signal, wherein the generating the closed captioning data is based, at least in part, on the generating the transcription data;
wherein the closed captioning data include the textual transcription.

17. The computer-implemented method of claim 16, wherein the analyzing the input audio signal further comprises detecting an additional speaker in the input audio signal, wherein the detecting the additional speaker includes detecting a change in the speech characteristics of the input audio signal, and wherein the closed captioning data include a textual indication that the speaker has changed from the speaker to the additional speaker.

18. The computer-implemented method of claim 17, wherein the detecting the additional speaker includes detecting the identity of the additional speaker, and wherein the closed captioning data include a textual identification of the identity of the additional speaker.

19. A computing device, comprising:
a processor; and
a memory that stores non-transitory computer readable instructions that, when executed by the processor, cause the computing device to perform the method of claim 1.

20. A non-transitory computer readable medium storing instructions that, when executed by a processor, cause a computing device to perform the computer-implemented method of claim 1.
